(19) United States
(12) Patent Application Publication
(10) Pub. No.: US 2013/0263970 A1
(43) Pub. Date: Oct. 10, 2013

(54) Fluid transfer coupling

(71) Applicants: Robert L. Schultz, JR., Ocean, NJ (US); Basil B. Tilling, Stanley, NC (US)

(72) Inventors: Robert L. Schultz, JR., Ocean, NJ (US); Basil B. Tilling, Stanley, NC (US)

(21) Appl. No.: 13/986,600

(22) Filed: May 17, 2013

Related U.S. Application Data
(63) Continuation-in-part of application No. 12/806,903, filed on Aug. 24, 2010, now Pat. No. 8,453,685.
Application No. 12/806,903 is a continuation of application No. 12/287,508, filed on Oct. 9, 2008, now Pat. No. 7,798,184.
Application No. 12/287,508 is a continuation of application No. 11/702,414, filed on Feb. 6, 2007, now abandoned.
Application No. 11/702,414 is a division of application No. 10/727,279, filed on Dec. 3, 2003, now Pat. No. 7,182,098.
(60) Provisional application No. 60/432,162, filed on Dec. 10, 2002.

(51) Int. Cl. B67D 7/54

(52) U.S. Cl. CPC B67D 7/54
USPC 141/301

(57) ABSTRACT

Provided herein are complementary couplers useful in providing a coupling through which liquids may be transferred from a first storage reservoir or tank to a second storage reservoir or tank, which can be an on-board fuel tank of a motorized vehicle. There is provided a first coupling which is configured to be in fluid communication with the interior of a vehicle's fuel tank, and a second coupling which is intended to be in fluid communication with the contents of a remote fuel storage reservoir. The disclosure also includes a process for charging a fuel reservoir on board of a motorized vehicle from a remote reservoir, wherein the vapor in the fuel reservoir is displaced by an equal volume of fuel delivered from said remote reservoir, and wherein the vapor in said fuel reservoir is simultaneously caused to be transferred to said remote reservoir, thus permitting no escape of the vapor from said fuel reservoir to the surrounding atmosphere. Through use of the present disclosure, spills of fuel are essentially eliminated, and the escape of vapors from the vehicle's fuel tank are prevented, thus preventing atmospheric hydrocarbon pollution.

### CROSS-REFERENCES TO RELATED APPLICATIONS

This application is a continuation-in-part of U.S. patent application Ser. No. 12/806,903 filed Aug. 24, 2010 which was a continuation of U.S. patent application Ser. No. 12/287,508 filed Oct. 9, 2008, now U.S. Pat. No. 7,798,184, which was a continuation of U.S. patent application Ser. No. 11/702,414 filed Feb. 6, 2007, now abandoned, which was a divisional of U.S. patent application Ser. No. 10/727,279 filed Dec. 3, 2003, now U.S. Pat. No. 7,182,098, and claims the benefit of U.S. Provisional Application No. 60/432,162 filed Dec. 10, 2002, the entire contents of all of which are herein fully incorporated by reference.

### TECHNICAL FIELD

This disclosure relates generally to fluid control and more particularly to couplings used in transferring a liquid substance from one reservoir in which a liquid is stored to a second reservoir. In some embodiments the invention relates to couplings useful in transferring a liquid hydrocarbon fuel from a storage vessel to a fuel tank on-board a motorized vehicle, such as an automobile.

### BACKGROUND

By the very nature of the utilization of liquid substances including, inter alia, noxious chemicals and liquid hydrocarbon fuels, it is frequently necessary to transfer a liquid fuel from a first storage vessel in which it is contained to a second storage vessel. One particular instance in which it is necessary to so transfer a liquid fuel is in the case of re-fueling an automobile during a racing event. Other instances include inter-plant transfers of liquids and gases in chemical plants, loading and off-loading tanker trucks and rail tankers, the re-fueling of aircraft, etc.

One particular class of automobile racing requires competing vehicles to travel an extended period of time to cover the pre-determined distance of the race. Such automobile races have been known for decades, and current NASCAR and other events include such races as the Indianapolis 500, the California 500, the Virginia 500, and the New England 300. Such automobile races typically require drivers and their cars to travel hundreds of miles from start to finish. Quite often, such races are carried out on a track, which may be circular, oval, or which may trace out a serpentine course.

Since the fuel-carrying capacity of a race car is limited by the rules of racing and the capacity of such tanks is not sufficient to enable the racer to complete an entire race on a single tank load of fuel, it is a general requirement that drivers must take pit stops periodically for re-fueling. The nature of racing is such that the first racer to cross the finish line is usually declared the winner, and the amount of time used by a racer for combined maintenance operations including re-fueling can be a significant factor in determining the outcome of a given race. Hence, it is highly desirable from the standpoint of a racing team that time expended in re-fueling and other pit-stop operations is kept to an absolute minimum.

Current state-of-the-art for re-fueling a racing vehicle in a circle-track application is for the racer to pull their car into a “pit-stop” for servicing. As is customary, the on-board fuel tank of a racing vehicle includes an inlet conduit through which fuel is admitted to the tank during re-fueling. There is also a cap or other means of sealing the inlet conduit from the surrounding environment after a re-fueling of the vehicle is complete. A headspace volume exists above the liquid level of the fuel in the tank. Initially, when the tank is full, the headspace volume is at its minimum. As fuel is consumed, the headspace volume increases, and reaches its maximum when all of the liquid fuel formerly contained in the tank has been consumed. During a re-fueling, members of the pit crew tote a large funnel-shaped recharging tank or “dump can” which contains a desired amount of a motor fuel, sometimes about 11.5 gallons in the case of some racing events. The recharging tank includes a fitting on its lower extremity which is complementary to that on the end of the inlet conduit on the vehicle's fuel tank. Once the vehicle comes to a stop, the pit crew removes the cap from the fuel tank inlet. Then, the fitting on the recharging tank is mated to the fitting on the tank inlet to form a sealed conduit through which fuel may pass from the recharging tank to the vehicle's on-board fuel tank. A valve disposed on the recharging tank is opened, and fuel contained within the recharging tank is drawn by gravity into the on-board fuel tank of the vehicle.

The re-fueling of a racing vehicle is undertaken as expediently as possible while minimizing fuel loss during the operation. However, one disadvantage of current re-fueling methods is that large volumes of liquid fuel are spilled onto the pavement and portions of the vehicle being re-fueled. A volume of fuel lost by spillage in re-fueling operations during the course of a race can be several gallons, such losses occurring primarily when the recharging tank is removed from the inlet conduit on the receiving vessel. While pit crews are well-equipped to deal with inadvertent fires that may occasionally occur, there are immediate health risks to pit crew personnel other than the fire hazard. For example, modern racing engines are typically designed to have an effective compression ratio in excess of 10:1, and these high compression ratio engines require fuels having high octane ratings. Volatile anti-knock compounds such as tetraethyl lead and the like are sometimes formulated into racing fuels as octane boosters. These lead compounds are volatile and since they are known health hazards, the issue of inhalation of tetraethyl lead and related compounds as a health hazard to pit crews is a serious matter. In addition, any un-necessary release of raw hydrocarbon fuels into the atmosphere is a public health concern.

Another issue for automobiles is the concept of vapor lock. Vapor lock is a condition manifest by the pressure in the headspace above the fuel in an on-board fuel tank being lower than normal atmospheric pressure. Such a condition is caused to exist by virtue of the fuel pump removing fuel from the fuel tank, without the same volume of air being admitted into the tank to compensate for the lost volume of fuel owing to the fuel tank being sealed off from the atmosphere. Eventually, the fuel pump is required to pump fuel from an area of reduced pressure, and, not being designed for such use, a less-than-desired amount of fuel is delivered to the engine, which can result in decreased engine performance.

### SUMMARY

Provided are couplers useful for facilitating transfer of a liquid from a first vessel to a second vessel with countercurrent transfer of vapor from the second vessel to the first vessel. In some embodiments a coupler as provided comprises a spring-biased quasi-cylindrical sleeve that is slidably disposed within a cover. The sleeve is hollow, has an interior and an exterior wall, and the exterior wall is configured sufficiently to cause upon application of force against the pressure of the spring, the opening of a first passage through which liquid is able to pass, and the opening of a second passage that is separate and distinct from said first passage through which vapor is able to pass within the coupler. The first passage is disposed through the interior of the sleeve and the second passage is disposed exterior to the wall of the sleeve, with the exterior wall of the sleeve comprising at least a portion of the boundary of the second passage.

### BRIEF DESCRIPTION OF THE DRAWINGS

In the annexed drawings:

FIG. 1 shows an exploded perspective view of a coupler according to some embodiments of the invention

FIG. 2 shows a perspective view of a coupler base according to some embodiments of the invention;

FIG. 3 shows an overhead view of a coupler base according to some embodiments of the invention;

FIG. 4 shows a perspective view of a cover component of a coupler according to some embodiments of the invention;

FIG. 5 shows a side view of a cover component of a coupler according to some embodiments of the invention;

FIG. 6 shows a bottom perspective view of a cover component of a coupler according to some embodiments of the invention;

FIG. 7 shows a perspective view of a sleeve component of a coupler according to some embodiments of the invention;

FIG. 8 shows a side view of a sleeve component of a coupler according to some embodiments of the invention;

FIG. 9 shows a perspective view of a poppet guide component of a coupler according to some embodiments of the invention;

FIG. 10 shows a side view of a poppet guide component of a coupler according to some embodiments of the invention;

FIG. 11 shows an underside view of a poppet guide component of a coupler according to some embodiments of the invention;

FIG. 12 shows a top perspective view of poppet and shaft components according to some embodiments of the invention;

FIG. 13 shows an underside perspective view of poppet and shaft components according to some embodiments of the invention;

FIG. 14 shows a side view of poppet and shaft components according to some embodiments of the invention;

FIG. 15 shows a bottom view of poppet and shaft components according to some embodiments of the invention;

FIG. 16 shows a perspective view of an assembled coupler according to some embodiments of the invention;

FIG. 17 shows a top view of an assembled coupler according to some embodiments of the invention;

FIG. 18 shows an overhead perspective view of an assembled coupler according to some embodiments of the invention;

FIG. 19 shows an underside perspective view of an assembled coupler according to some embodiments of the invention;

FIG. 20 shows an underside view of an assembled coupler according to some embodiments of the invention;

FIG. 21 shows an exploded perspective view of a coupler according to some embodiments of the invention;

FIG. 22 shows a side view of a base of a coupling according to some embodiments of the invention;

FIG. 23 shows an overhead view of a base of a coupling according to some embodiments of the invention;

FIG. 24 shows a perspective view of a base of a coupling of a coupling according to some embodiments of the invention;

FIG. 25 shows a side view of a billet body component of a coupling according to some embodiments of the invention;

FIG. 26 shows an overhead view of a billet body component of a coupling according to some embodiments of the invention;

FIG. 27 shows a perspective view of a billet body component of a coupling according to some embodiments of the invention;

FIG. 28 shows a perspective view of a cover component of a coupling according to some embodiments of the invention;

FIG. 29 shows a bottom view of a cover component of a coupling according to some embodiments of the invention;

FIG. 30 shows a perspective view of an inner sleeve component of a coupling according to some embodiments of the invention;

FIG. 31 shows a top view of an inner sleeve component of a coupling according to some embodiments of the invention;

FIG. 32 shows a side view of an inner sleeve component of a coupling according to some embodiments of the invention;

FIG. 33 shows a bottom view of an inner sleeve component of a coupling according to some embodiments of the invention;

FIG. 34 shows a perspective view of an outer sleeve component of a coupling according to some embodiments of the invention;

FIG. 35 shows a top view of an outer sleeve component of a coupling according to some embodiments of the invention;

FIG. 36 shows a side view of an outer sleeve component of a coupling according to some embodiments of the invention;

FIG. 37 shows a bottom view of an outer sleeve component of a coupling according to some embodiments of the invention;

FIG. 38 shows an overhead perspective view of a poppet according to some embodiments of the invention;

FIG. 39 shows a top view of a poppet according to some embodiments of the invention;

FIG. 40 shows a side view of a poppet according to some embodiments of the invention;

FIG. 41 shows a bottom view of a poppet according to some embodiments of the invention;

FIG. 42 shows a perspective view of an assembled coupler according to some embodiments of the invention;

FIG. 43 shows a bottom view of an assembled coupler according to some embodiments of the invention;

FIG. 44 shows an overhead perspective view of an assembled coupler according to some embodiments of the invention;

FIG. 45 shows an overhead perspective view of an assembled coupler according to some embodiments of the invention;

FIG. 46 shows a side cutaway view of a coupler according to some embodiments of the invention;

FIG. 47 shows a side cutaway view of a coupler that is complementary to the coupler depicted in FIG. 47 according to some embodiments of the invention;

FIG. 48 shows a side cutaway view of the couplers depicted in FIGS. 46, 47 complementarily connected to one another;

FIG. 49 shows a side view of a remote fuel reservoir having a coupler provided hereby attached thereto; and

FIG. 50 shows a side view of a fuel storage tank having a coupler provided hereby attached thereto.

### DETAILED DESCRIPTION

A fuel transfer coupling according to some embodiments of present inventions comprises a first portion at a first location selected by the user that is in fluid communication with a receiving vessel which can include without limitation a reservoir or tank being on-board of motorized vehicles such as trucks, automobiles, aircraft, sea-going vessels, or stationary such as in a chemical plant, food-processing facility or any other operation involving transfer and storage of chemicals. There is also a remote portion of the coupling disposed at a second location selected by the user, the remote portion being in fluid communication with a source of liquid hydrocarbon, chemical, fuel, etc. that is to be transferred, delivered or provided, etc. to the receiving vessel to which the first portion is in fluid communication. In some embodiments, the on-board portion may be referred to as the male coupler and the remote portion of the coupling may be referred to as the female coupler for convenience; however, the first portion in fluid communication with the receiving vessel including a fuel tank aboard a motorized vehicle can be selected to have a female configuration, and the second portion in fluid communication with the vessel containing the liquid to be transferred can be selected to have a male configuration.

In some embodiments a coupling as provided herein is used in transferring a fluid to a receiving vessel that is not on board of a motorized vehicle, such as transfers of any chemical including hydrocarbons from one storage vessel to another storage vessel, for example in a chemical plant wherein the first portion of a coupling as provided herein is attached to a first end of a segment or line of conduit including hoses and pipes, and the second portion of a coupling as provided herein is attached to the second end of that same conduit line or segment. Other embodiments include a standing tank containing a liquid substance having a hose attached to its outlet to which either a male or female coupling portion provided herein is attached. In some embodiments the fluid that is to be transferred is caused to be under an applied pressure that is greater than ambient pressure by any selected amount to hasten liquid flow, such as by employment of a fluid pump.

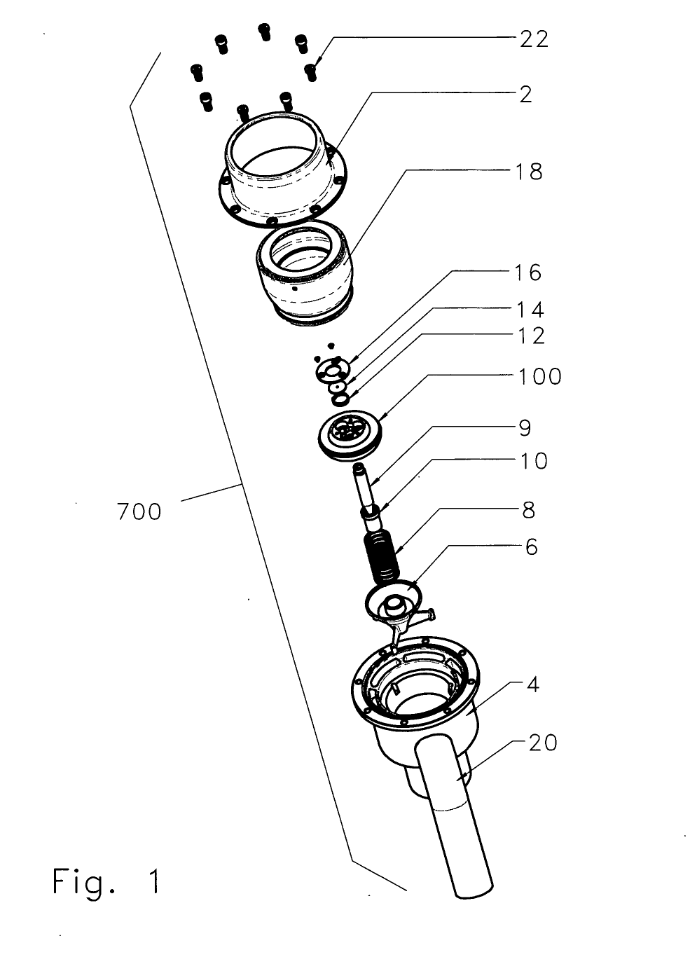

Referring to the drawings, and initially to FIG. 1 there is shown an exploded view of a coupler 700 according to some embodiments with its various components, including vapor tube 20, male coupler base 4, conical poppet guide 6, spring 8, poppet bushing 10, poppet shaft 9, poppet 100, vent spring 12, vent seat 14, retainer ring 16, sleeve 18, male coupler cover 2, and fasteners 22.

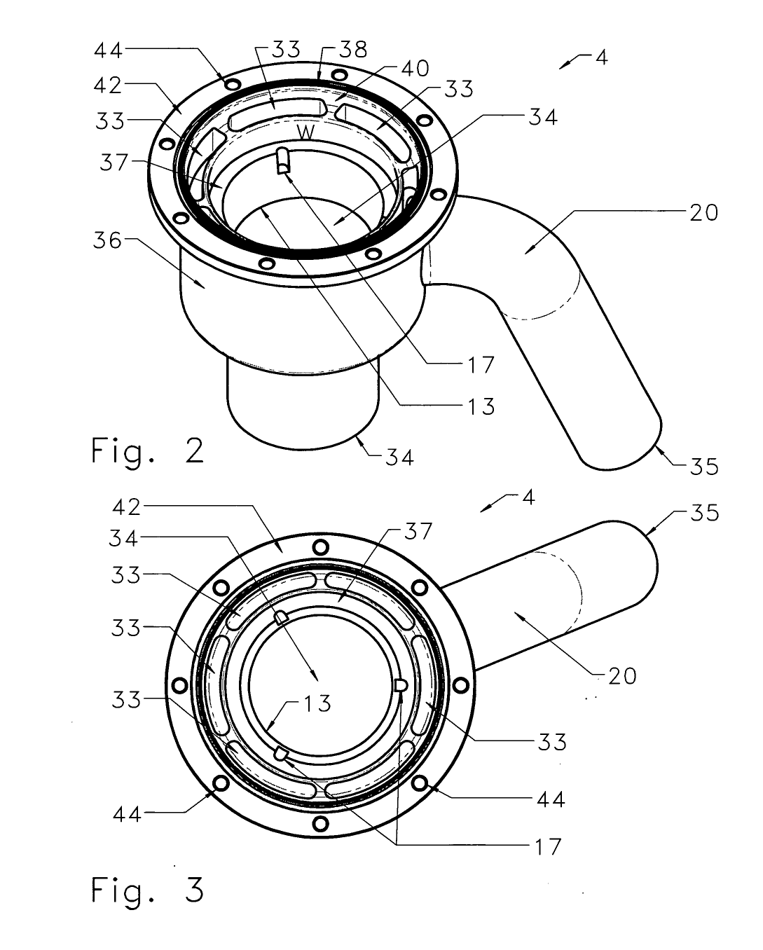

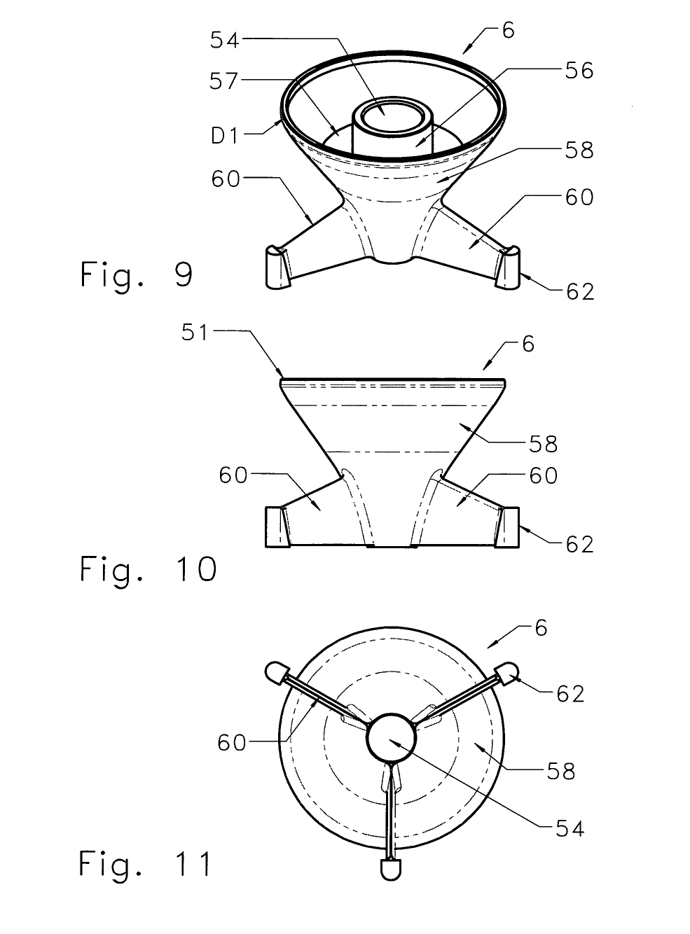

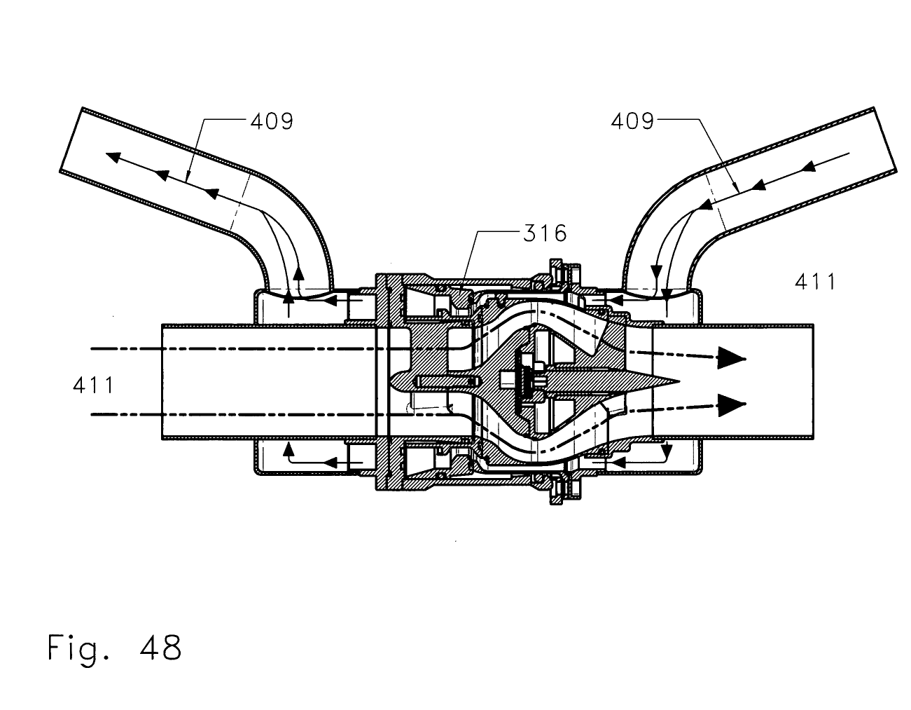

In FIG. 2 is shown a perspective view of male coupler base 4, which includes a central bore 34 through which a liquid substance such as a normally-liquid hydrocarbon fuel or other selected material is intended to flow. Central bore 34 has a first end 39 (FIG. 16) which may be connected to the inlet pipe of a fuel tank, and a second end portion which extends into the coupler base and terminates at a point within the male coupler base as shown. Disposed about the central bore 34 is a shrouding enclosure 36 which forms a chamber disposed co-axially about central bore 34 for the purpose of providing a pathway for a vaporous substance such as hydrocarbon or chemical vapors or air vapor to pass through the various holes 33 disposed through surface 40 of the male coupler base as shown, the holes 33 being in fluid communication with the outlet portion 35 of the vapor tube 20 via enclosure 36. In some embodiments holes 33 are shaped as slots or oblong, ovoid, and in other embodiments holes 33 are circular or rectangular, and in some embodiments surface 40 is planar. This structure can be likened to a condenser as used in the chemical arts, which consists of a tube having a water jacket about it, with an inlet and outlet for the cooling water, and a tube disposed therethrough which the vapor to be condensed is caused to pass. The functional outlet of shrouding enclosure 36 comprises various holes 33 and its inlet is vapor tube 20 when this coupler is attached to a liquid-receiving vessel. Flange 42 is disposed at one end of the base having a plurality of holes 44 disposed therethrough along its periphery for the purpose of receiving fasteners for affixing coupler base 4 to other components of coupler 700 including cover 2. In some embodiments, holes 33 are present through surface 40, which surface 40 is disposed on a plane substantially parallel to but different from and beneath that of the planar surface of flange 42. Thus, in some embodiments the plane of the flange portion 42 is above (more distal from the first end of central bore 34 than surface 40) than of the surface 40. At the intersection of these two features there is a ledge which can be beveled or feature a distinct edge, and featuring a wall W, which in some embodiments is cylindrical. In some embodiments an annular lip is present at elevation 38, upon which an o-ring seal 46 is mounted (not shown) in the finished assembly. A circumferential ledge 37 is present adjacent to wall W into which skirt portion of sleeve 18, including an o-ring present in circumferential groove 511 (FIG. 7), is moveably disposed, the travel of sleeve 18 within base 4 during coupling or uncoupling of the couplings herein being limited by the location of ledge 37, which ledge acts as a stop for sleeve 18. Slots 17 are provided for receiving contact features 62 slidably inserted therein (FIGS. 9-11) during assembly of the unit. In some embodiments, the opening of central bore at bottom of taper 13 is smaller in diameter than the bore at the innermost diameter of circumferential ledge 37, thus providing a taper to a segment of the central bore 34. When the degree of the taper is matched to adjacent and other components that are contoured to themselves also be tapered or have smooth curves and other features as herein collectively shown or described, a great improvement is achieved over the rate of flow of a liquid through the joined couplings hereof compared to like couplings of prior art. In some embodiments when sleeve 18 is depressed so that it is in an open position such as depicted in FIG. 48, the bottom of skirt 55 of sleeve 18 resides against ledge 37. In some embodiments base 4 includes a smooth transition in diameter between a segment along central bore 34 downstream and adjacent to the opening at bottom of taper 13 and the interior wall of sleeve 18, when sleeve 18 is in such open position, the transition comprising a tapered segment corresponding to the wall of central bore 34 disposed between the opening at bottom of taper 13 and the innermost edge of or adjacent to ledge 37. In some embodiments, the degree of taper is sufficient to provide a smooth transition in diameter between the inner wall of sleeve 18 and the diameter of central bore 34 that is downstream of bottom of taper 13 with respect to liquid flow.

In FIG. 3 is shown an overhead view of male coupler base 4, including central bore 34, flange 42, holes 44, vapor tube 20, holes 33, circumferential ledge 37, bottom of taper 13, and slots 17. An o-ring seal 46 is present at the elevation 38 shown in FIG. 2.

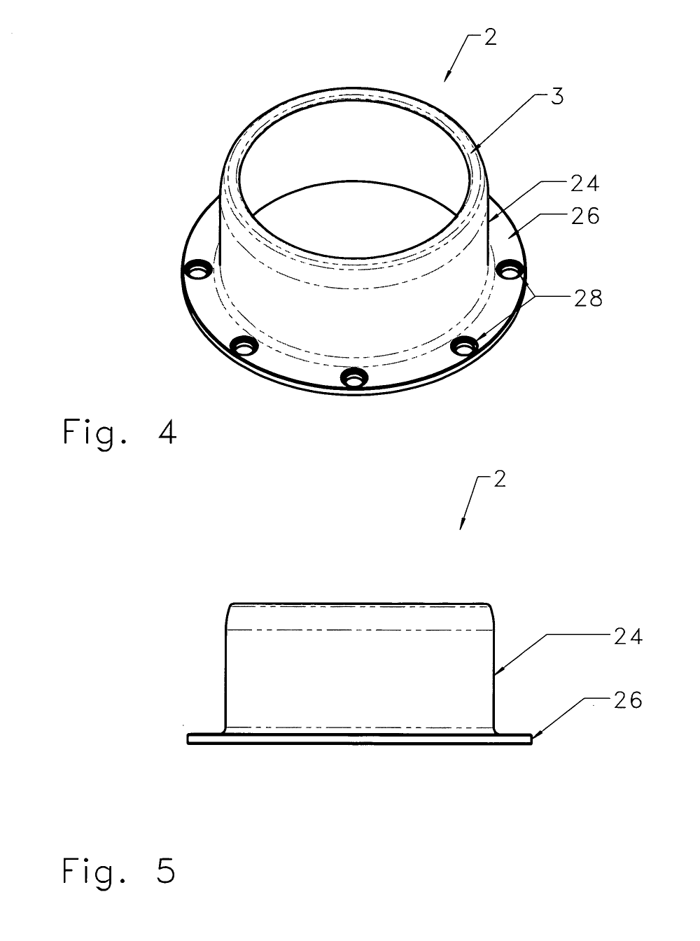

FIG. 4 shows a perspective view of the male coupler cover 2, having an outer wall 24, top surface 3, and flange 26 which includes a plurality of holes 28 disposed about its periphery for connection to the male coupler base 4 once all components of coupler 700 have been assembled and installed within base 4, using conventional fasteners in some embodiments including screws. In FIG. 5 is shown a side view of male coupler cover 2, including outer wall 24 and flange 26.

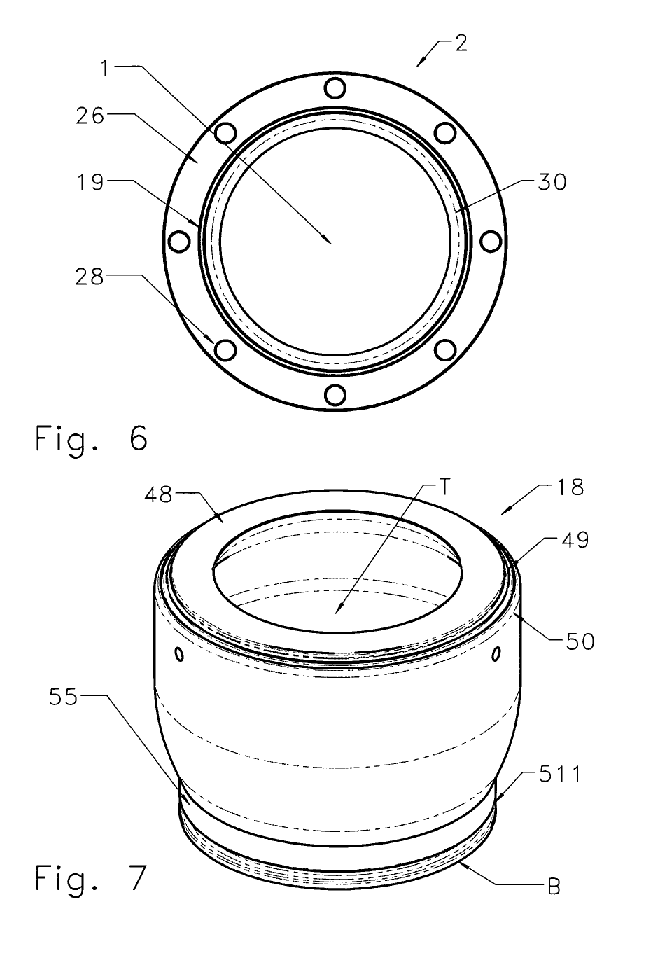

FIG. 6 shows a bottom view of the male coupler cover 2, including flange 26, plurality of holes 28, annular groove 19 which extends about the hollow interior 1 adjacent to the flange 26 and receives the o-ring seal 46 (not shown) in a sealing relationship in the completed assembly. There is a circumferential beveled edge 30 within the interior of cover 2 that is configured to sealingly engage o-ring 50 present at the exterior of sleeve 18.

FIG. 7 depicts sleeve 18, which in some embodiments is configured as a quasi-cylindrical hollow shell or sleeve having features shown and described herein. Sleeve 18 is hollow in its interior, as shown in cross-section in FIGS. 46, 48 and has an open top T and an open bottom B. A hollow interior space is thus present within the confines of the wall and top and bottom of sleeve 18. In some embodiments top surface 48 is flat, and there is a sloping circumferential shoulder portion 49 featuring a ring land in which resides an o-ring seal 50 in the assembled device. O-ring seal 50 is disposed to seal between the sloping shoulder 49 and beveled edge 30 from FIG. 6 previous when the couplers 700, 701 are not coupled to one another. In the assembled coupler 700 there is also an o-ring seal disposed in a circumferential groove 511 present on the skirt of sleeve 18 adjacent to the bottom portion B, for sealing the skirt portion of sleeve 18 against the wall portion W of the bore in FIG. 2 in the assembled device. Thus, the skirt portion of sleeve 18 is slidably disposed within a bore defined by circumferential wall W adjacent to the circumferential ledge 37.

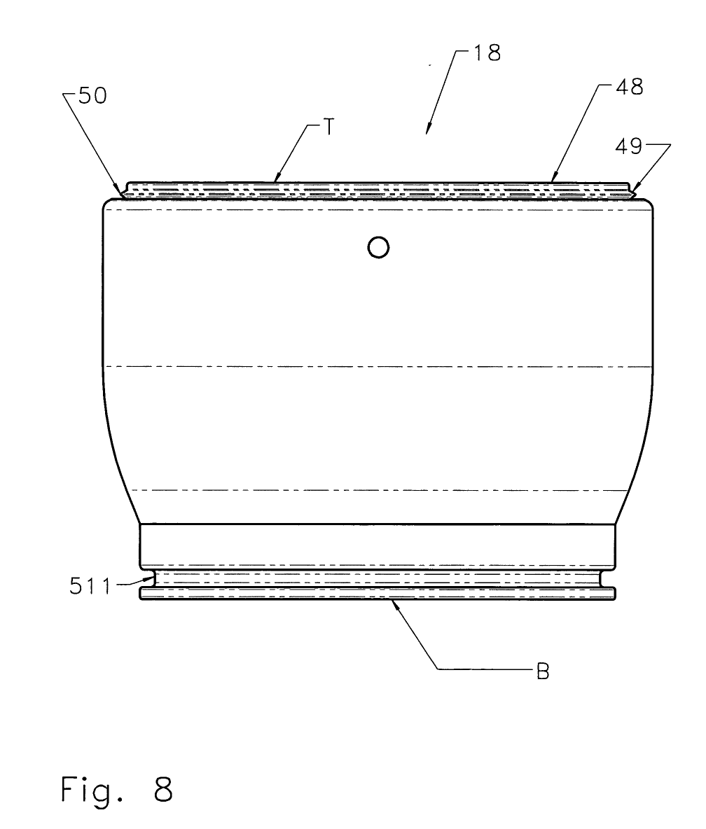

FIG. 8 shows a side elevation view of a sleeve 18 according to some embodiments and depicts the locations of the top surface 48, sloping shoulder 49, location of o-ring seal 50, groove 511 for holding an o-ring seal.

FIG. 9 shows a perspective view of a poppet guide 6 according to some embodiments featuring a truncated cone configuration which contributes in providing favorable fluid dynamics for liquids passing through a coupling including couplers 700, 701 as taught herein, resulting in low resistance to fluid flow and increased fluid flow rates over prior art couplings. In some embodiments poppet guide 6 a singular construct of a machined metal, alloy, polymer, composite, etc. including a funnel-shaped cone element 58 having centrally disposed therein a poppet guide bore 54 having a a wall 56 with a wall thickness and a plurality of support arms 60. In some embodiments support arms 60 include contact features 62 at the ends thereof configured to securely reside within slots 17 present in base 4 (FIGS. 2, 3) at and extending below circumferential ledge 37. In some embodiments contact features 62 are shaped as truncated cylinders, but any suitable functionally-equivalent matching complementary arrangement between contact features 62 and slots 17 can be employed. Poppet guide 6 is rigidly maintained in a stationary position in an assembled coupler partly due to the contact features 62 residing in slots 17. Poppet guide bore 54 extends all the way through poppet guide 6 and is dimensioned to receive poppet bushing 10 (FIG. 1), which itself is dimensioned to slidably receive poppet shaft 9. The diameter at D1 of FIG. 9 of the upper portion of cone element 58 is slightly less than that of the internal diameter of the bottom portion B of sleeve 18 shown in FIG. 7, which enables the skirt portion of sleeve 18 to be slipped over the cone at D1 and reside within the bore defined by wall W and atop contact features 62 of poppet guide 6 after the poppet guide 6 has been placed in position on the circumferential ledge 37 of FIG. 2 during assembly.

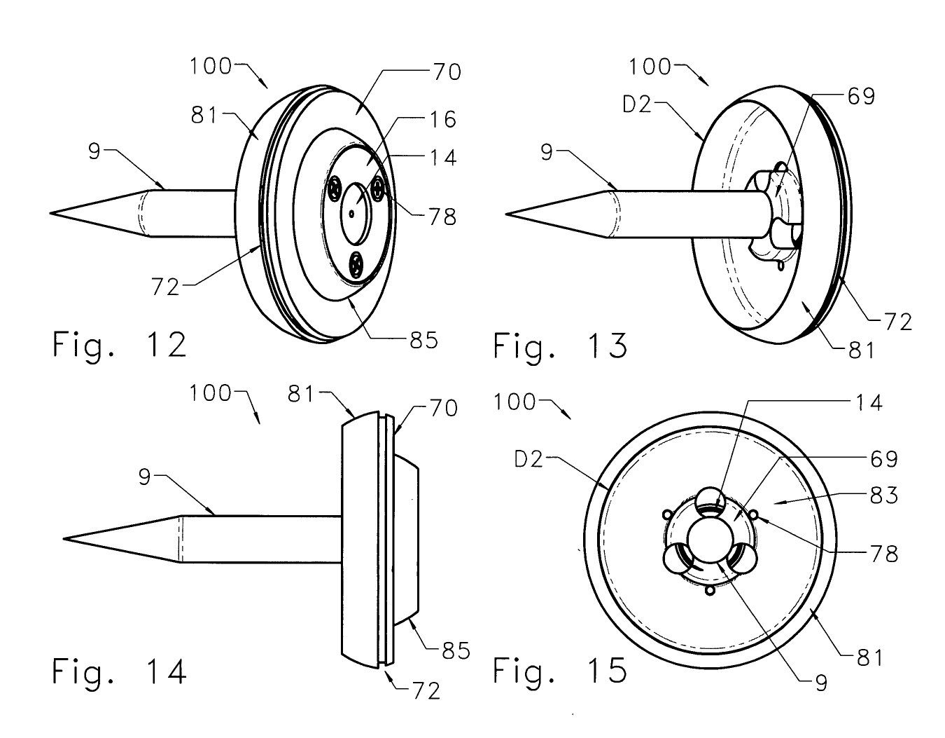

FIG. 10 is a side elevation view of poppet guide 6 showing the respective locations of cone element 58, contact features 62, top ring portion 51 at diameter D1, and support arms 60 according to some embodiments.

FIG. 11 shows a bottom view of poppet guide 6 showing the respective locations of poppet guide bore 54, support arms 60, contact features 62, and cone element 58.

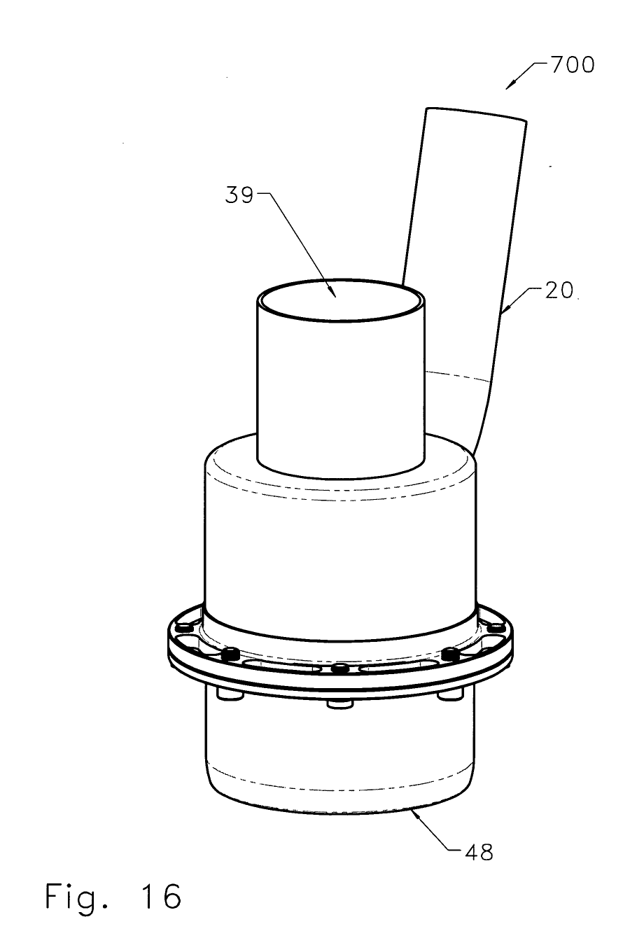

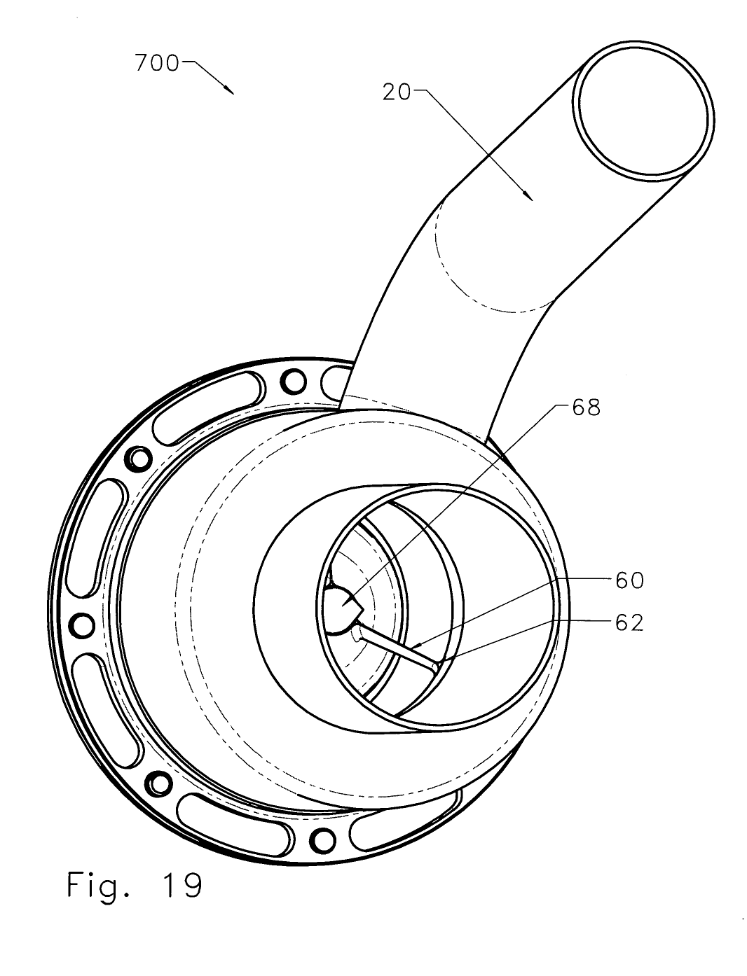

FIG. 12 is a perspective view of a combination including poppet shaft 9 and poppet 100, showing top surface 70 of poppet 100, valve face 81, and o-ring land 72 which is a circumferential groove (FIG. 14). Poppet shaft 9 in some embodiments is cylindrical having either a point or being smooth at its tapered distal end 68 (FIG. 19) which functions synergistically with the remaining components of coupler 700 to enhance flow rates of liquids passing through couplers 700, 701 when engaged. In some embodiments vent disc 14 is disposed in a recess within elevated portion 85 present upon flat top surface 70, the vent disc being maintained in position by retainer ring 16, itself being maintained in position by means of machine screws 78 threaded into holes present on elevated portion 85 of top surface 70. Vent disc 14 in some embodiments includes a hole 15 that passes through the vent disc itself. In some embodiments a spring (not shown) mechanically biases vent disc 14 against retainer ring 16. In some embodiments vent disc 14 is slidably disposed within a bore disposed through elevated portion 85.

FIG. 13 is a lower perspective view of the poppet 100, showing valve face 81, o-ring land 72, and stem receiver boss 69 which is configured to receive the proximal end of poppet shaft 9. Poppet 100 features valve face 81 having innermost diameter at D2 and dimensioned sufficiently to complement the contour of poppet guide 6 at its diameter D1 (FIG. 9) in a smoothly-transitioning fashion, these components having streamlined exterior contours as shown herein which synergistically function with other features and components herein to provide decreased resistance to flow of liquid substances through central bore 34.

FIG. 14 shows a side elevation view of poppet 100 and stem 9 including top surface 70, elevated portion 85, valve face 81, and ring land 72. FIG. 15 depicts a bottom perspective view of poppet 100 having a diameter at D2, stem receiver boss 69, vent disc 14, valve face 81, poppet stem 9, bottom surface 83, and ends of machine screws 78. In some embodiments D2 and valve face 81 are dimensioned sufficiently to substantially match D1 of poppet guide 6 at the top portion of cone 58 (FIG. 10) so that valve face 81 is disposed at the top portion of the cone 58 with no irregular edges or other flow-inhibiting features or profile discontinuities present at the juncture of poppet guide 6 and poppet 100 past which a liquid substance flows, providing minimal turbulence with respect to liquid flow at such juncture. Poppet stem 9 is of such diameter as to provide a snug fit in by which poppet stem 9 is slidably disposed within poppet guide bore 54.

FIG. 16 shows a side view of male coupler 700 in assembled form, having its components shown in FIG. 1 and described herein contained within the coupler cover 2 and coupler base 4. To assemble male coupler 700, one may begin by securing coupler base 4 in a stationary position. Next, poppet guide 6 is placed into position so that contact features 62 of poppet guide 6 reside in slots 17 with poppet spring seat 57 facing upwards, as shown in FIGS. 1, 9. Poppet 100, poppet shaft 9 and poppet bushing 10, spring 8, spring 12, vent disc 14, and retaining ring 16 are assembled as shown and inserted into sleeve 18 from the bottom B (FIG. 8) so that an o-ring seal disposed in land 72 contacts the inner wall of sleeve 18 at a location on the interior of the sloping shoulder 49, which in some embodiments is a machined bevel that sealingly engages with o-ring seal in land 72 when coupler 700 is not coupled to coupler 701. Poppet spring 8 is positioned at spring seat 57 (FIG. 9), and sleeve 18 (with poppet 100 inside it) is then placed into position so that at least part of the skirt portion of sleeve 18 resides within a bore having a wall W of coupler base 4 such that spring 8 mechanically biases poppet 100 towards a closed position in which o-ring present in land 72 sealingly engages an interior wall portion of sleeve 18. Male coupler cover 2 is placed over sleeve 18 and using fasteners is secured to coupler base 4, to provide male coupler 700. FIG. 16 also depicts the vapor tube 20, top surface 48, and first end 39 of central bore 34.

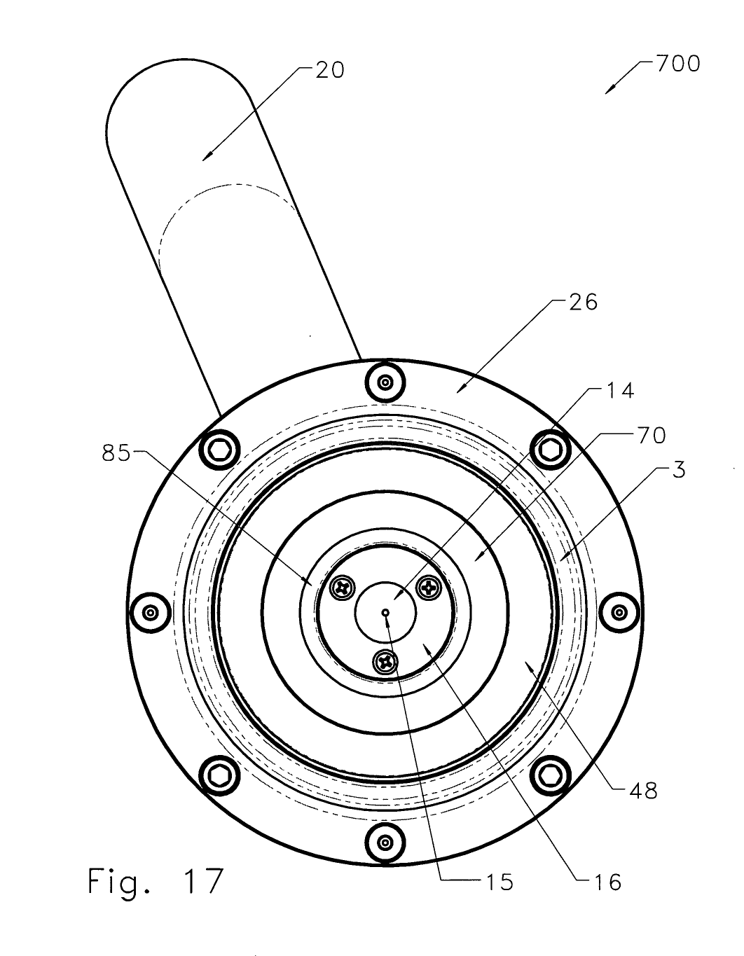

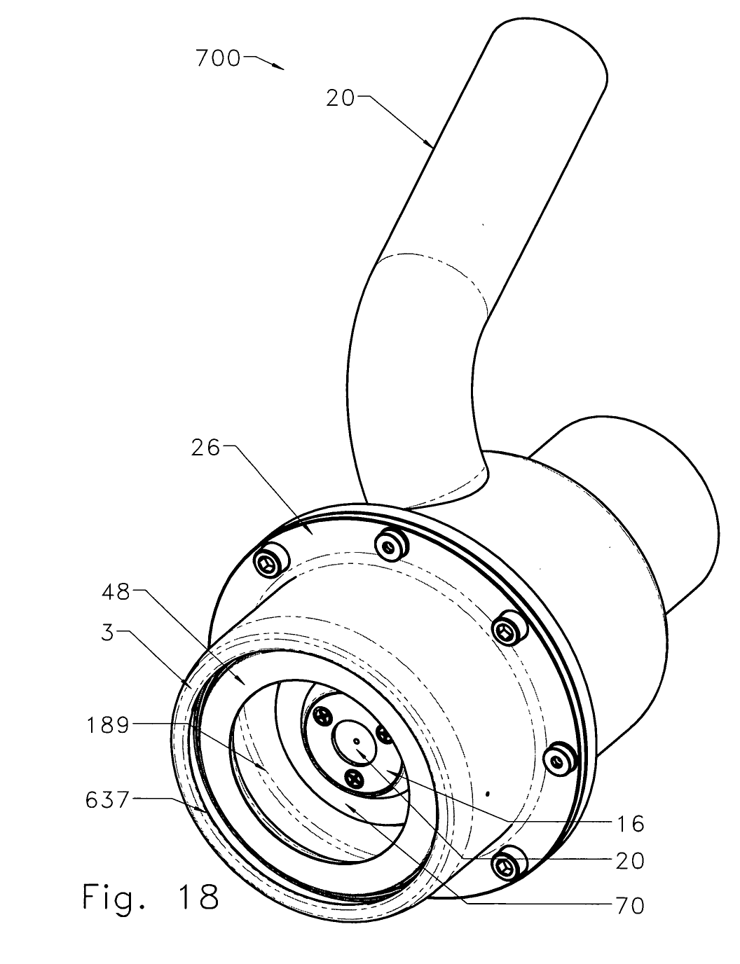

FIG. 17 shows a top view of the assembled male coupler 700, showing the respective locations of vent disc 14, optional vent hole 15, retaining ring 16, vapor tube 20, flange 26, flat top surface 48 of sleeve 18, elevated portion 85, top surface 70 of poppet 100, and top surface 3 of the male coupler cover 2.

In some embodiments during coupling of couplers 700, 701 as provided herein, as flat top surface 70 of poppet 100 is depressed slightly at first, against the pressure of spring 8, both poppet 100 and sleeve 18 move into the assembly as a whole, until skirt 55 of sleeve 18 has bottomed out against circumferential ledge 37 of base 4. The movement of sleeve 18 to its bottomed-out position creates an annular opening at gap 637 (FIG. 18) between the inner wall of male coupler cover 2 and outer wall of sleeve 18 by releasing the contact between the o-ring seal 50 and beveled edge 30. This slight depressing of the flat top surface 48 of sleeve 18 causes a fluid connection to exist between vapor tube 20 and space at gap 637 at the top portion of the assembly where o-ring seal 50 has separated from beveled edge 30, through the plurality of holes 33 in male coupler base 4.

Further depressing surface 70 of poppet 100 such as by poppet 154 in couplers 700, 701 when engaged creates an opening 189 between the outer periphery of the top surface 70 of the poppet 100 and the internal wall of sleeve 18, enabling a liquid fuel to pass through the inner volume of sleeve 18, through central bore 34 and to the inlet pipe on a vehicle's fuel tank or other receiving vessel. Vapor tube 20 is in some embodiments connected to a hose which is in fluid communication with the headspace vapor within the fuel tank or other receiving vessel. Thus, by depressing flat top surface 70 of poppet 100, a fluid communication between the headspace vapor in the fuel tank and the gap at 637 is created, and depression of poppet 100 creates a second passage to the receiving vessel, fuel tank, etc. for a liquid such as a motor fuel to flow through central bore 34. Spring 8 biases poppet 100 upwards. Poppet 100 is located centrally with respect to the opening at the top of sleeve 18, and the head of poppet 100 is of a diameter that is larger than the diameter of the circular opening in sleeve 18 adjacent to top surface 48, the contact of poppet 100 with sleeve 18 accordingly causing sleeve 18 to be effectively spring-biased by spring 8 as well. Sleeve 18 is held in position within cover 2 partly by the diameter and contour of the exterior wall of sleeve 18 at shoulder 49 being sufficient to engage with and be held by beveled edge 30 in the interior of coupler cover 2.

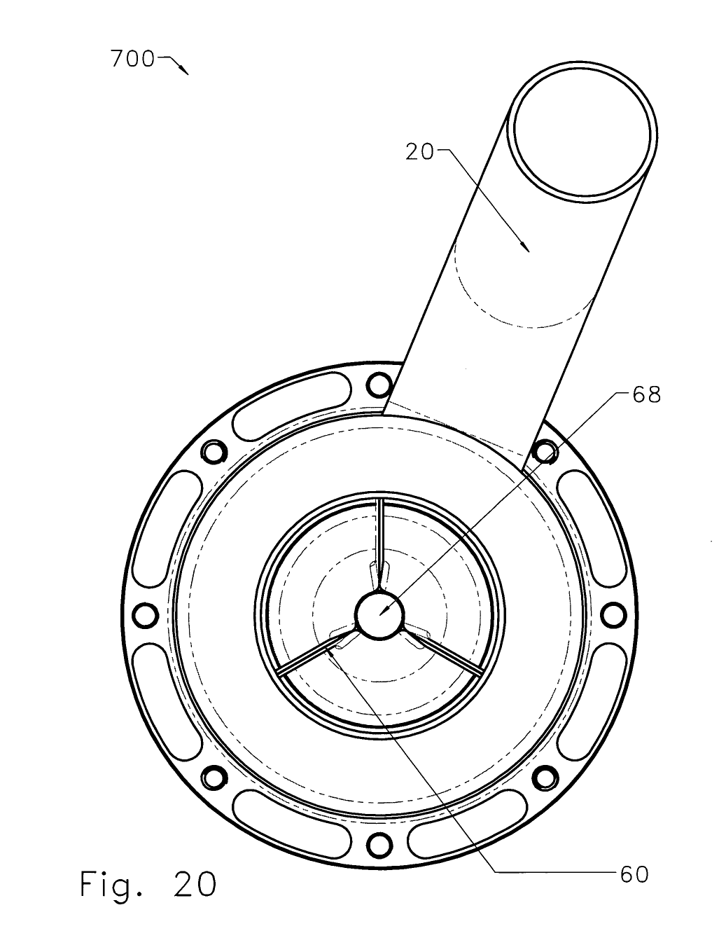

FIG. 19 shows the underside view of the coupler 700 when the poppet 100 is not depressed, including end 68 of poppet shaft 9, and FIG. 20 shows the same underside view.

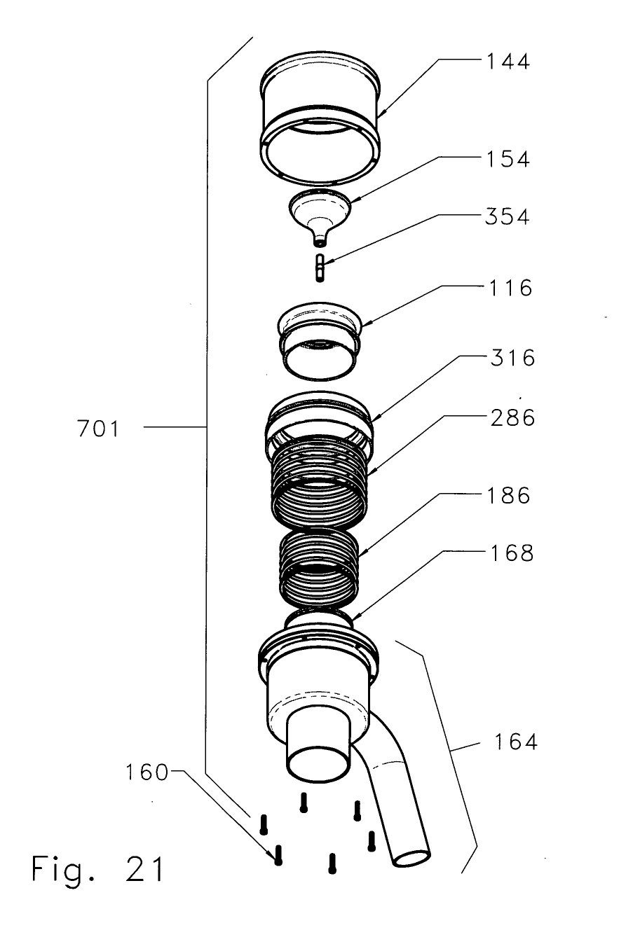

A liquid transfer coupling according to some embodiments of the invention comprises a remote coupler 701 which is in fluid communication with a source of liquid substance including chemicals, liquid fuel, etc. that is to be delivered to a tank aboard a motorized vehicle. Such remote coupler 701 may in some embodiments have a female character owing to its ability to receive or sheathe a male cover 2 of the coupler 700. Referring now to FIG. 21 there is shown an exploded view of a coupler 701 according to some embodiments including features such as coupler base 164, billet body 168, inner sleeve spring 186, outer sleeve spring 286, outer sleeve 316, inner sleeve 116, poppet retainer 354, poppet 154, and cover 144, described further below.

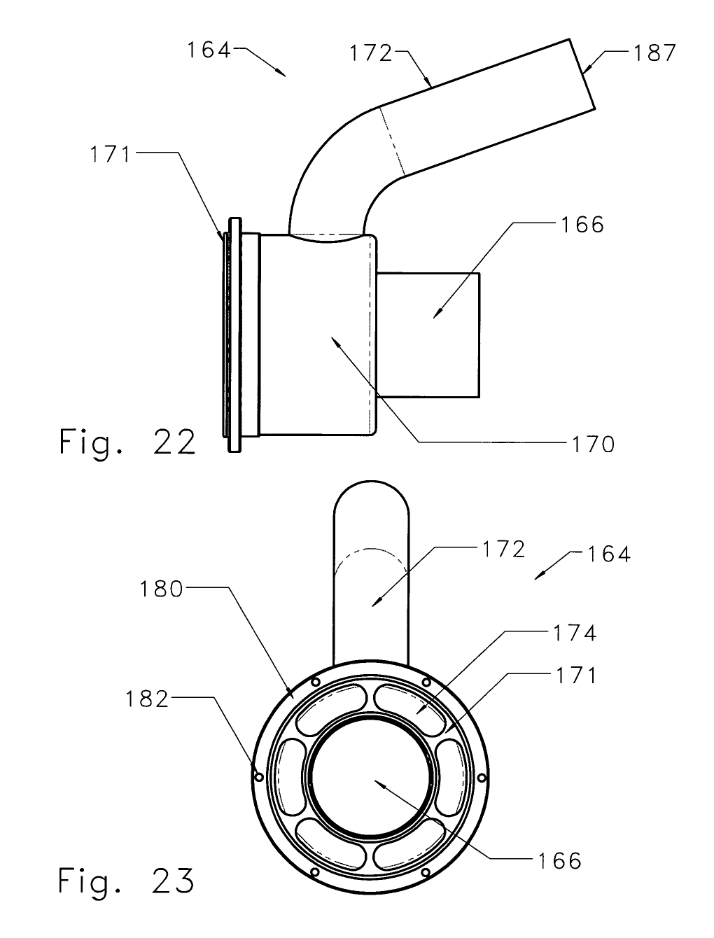

FIG. 22 shows a side elevation view of a coupler base 164 according to some embodiments, including central conduit 166, raised surface 171, shrouding enclosure 170 and outlet 187 of vapor tube 172.

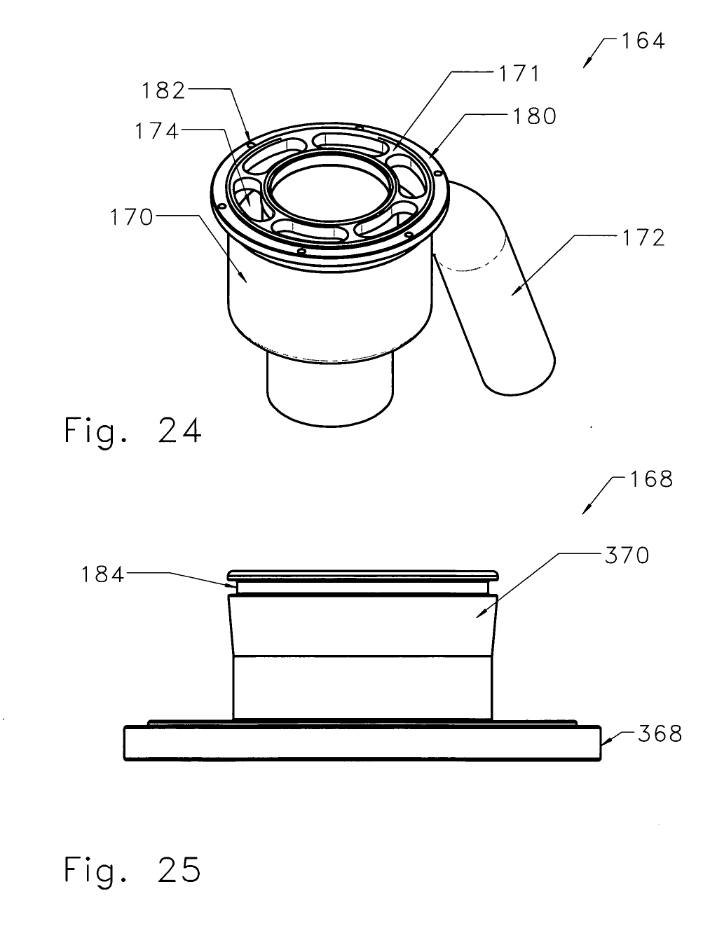

FIG. 23 shows a top view of the coupler base 164, including the central conduit 166, raised surface 171, holes 174, vapor tube 172, flange 180, and holes 182. Coupler base 164 includes a central conduit 166 through which a liquid substance is intended to flow. Disposed about central conduit 166 is enclosure 170 (FIG. 24) which envelopes central conduit 166, enabling headspace or other vapors, gasses, etc. to pass out of coupler 700 and through at least one and in some embodiments a plurality of holes 174 disposed through surface 171 into the confines of enclosure 170 and to the end of vapor tube 172.

FIG. 24 shows a perspective view of the upper portion of coupler base 164 for some embodiments, including raised surface 171, shrouding enclosure 170, holes 174, vapor tube 172, and outer annular flange 180 having a plurality of holes 182 disposed thereon.

FIG. 25 depicts a side elevation view of billet body 168, including its base 368, o-ring land 184, and central hub 370.

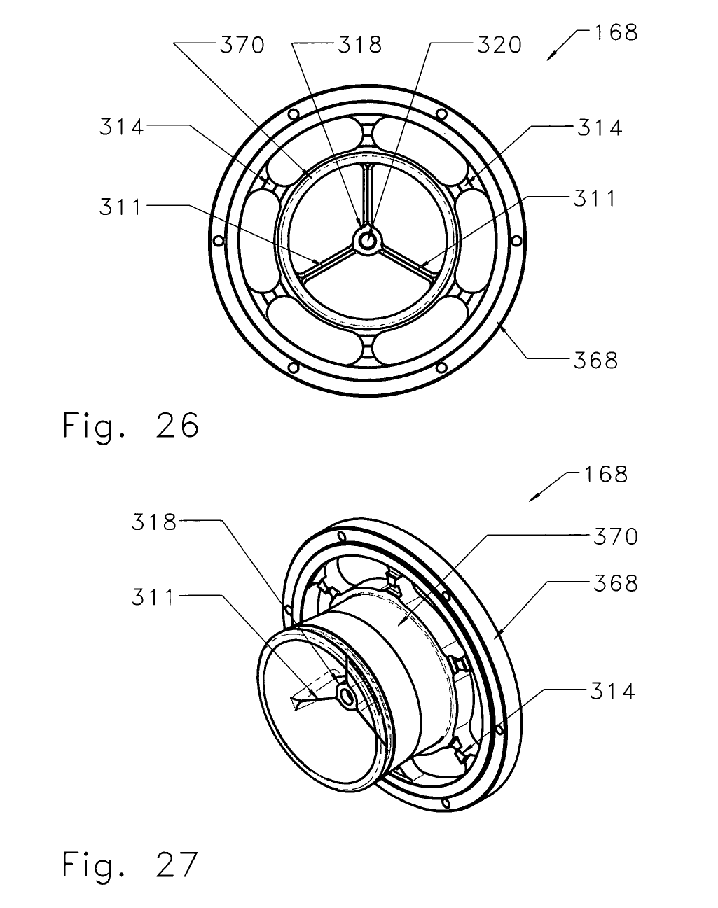

FIG. 26 shows an overhead view of billet body 168, including base 368 and hub 370. Hub 370 is centrally-located in some embodiments and is maintained in position by a plurality of radially-extending spoke or any other-shaped supports 314 present adjacent to holes through which vapors etc. are intended to pass exterior to the wall of hub 370, whilst liquid flows through the interior of hub 370 and through central conduit 166. In the interior of hub 370 is boss 318 having a bore 320 configured to receive poppet retainer 354 which in some embodiments is rod-shaped, boss 318 being maintained in position by a plurality of supports 311. In some embodiments, billet body 168 comprises a single piece of a machined, cast, investment cast, forged, or otherwise worked metal, polymer, composite material, or metallic alloy. Holes adjacent to supports 314 are analogous to holes 33.

FIG. 27 shows a perspective view of billet body 168, including its base 368, central hub 370, spoke supports 314, boss 318 and supports 311.

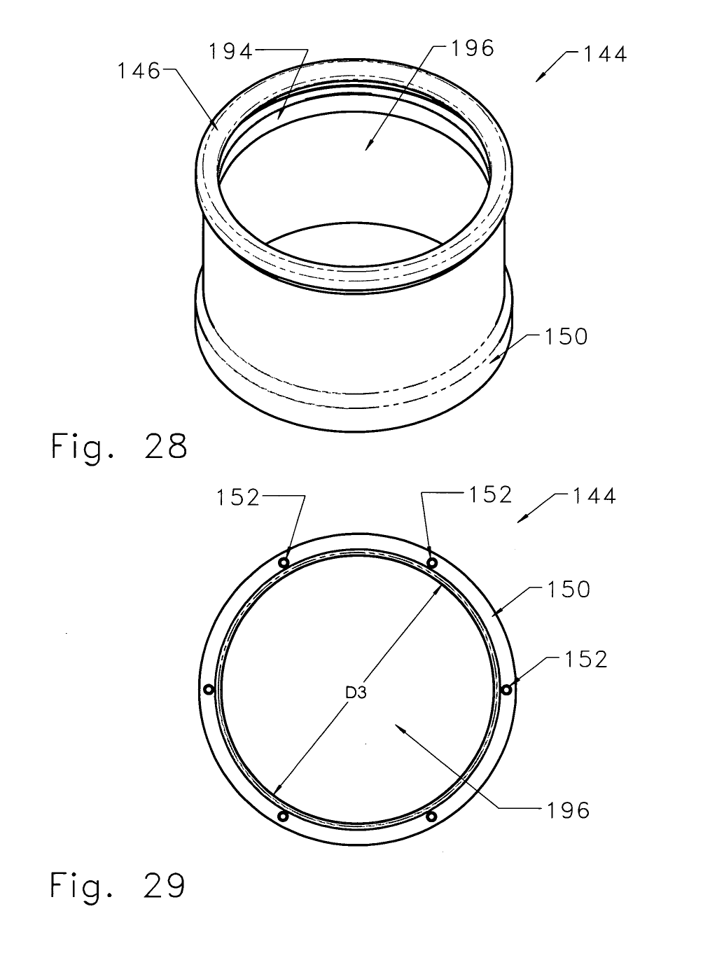

FIG. 28 shows a perspective view of coupler cover 144, shaped in the form of a hollow cylindrical shell, reminiscent in some sense of a cylinder sleeve. Coupler cover 144 includes a smooth bore 196 on its interior wall, excepting a raised band 194 near the top surface 146 that extends about the inner circumference of bore 196, band 194 creating a ring having a slightly smaller inner diameter than smooth bore 196. An o-ring seal 148 is disposed in an annular slot or ring land just below surface 146 at the upper end of coupler cover 144, which o-ring provides a seal around the outer surface of male coupler cover 2 when male coupler cover 2 is engaged with coupler cover 144. Also present is bottom 150, which is flared in some embodiments.

FIG. 29 shows a bottom view of coupler cover 144, including bottom 150 and a plurality of holes 152 which in some embodiments are threaded, disposed circumferentially about bottom 150, holes 152 being configured to receive a fastener that also passes through the holes 182 in coupler base 164, which are in the same configuration and spacing on both the coupler cover 144 and coupler base 164. Diameter D3 of the inner bore 196 of the coupler cover 144 is just slightly larger than the diameter of the raised surface 171, sufficient to enable coupler cover 144 to be securely fit over the coupler base 164.

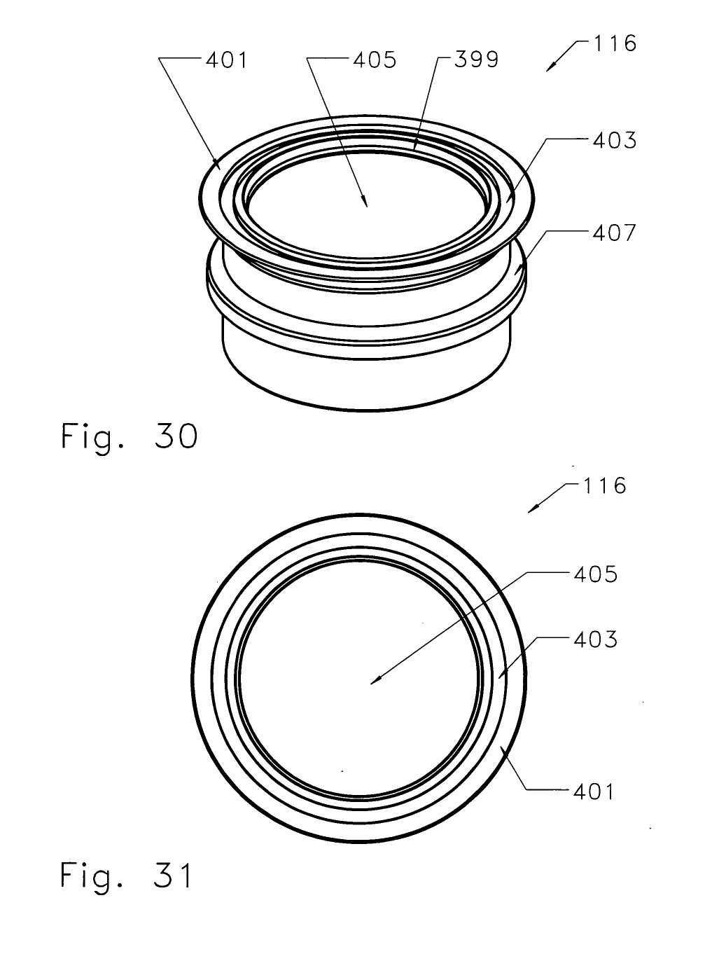

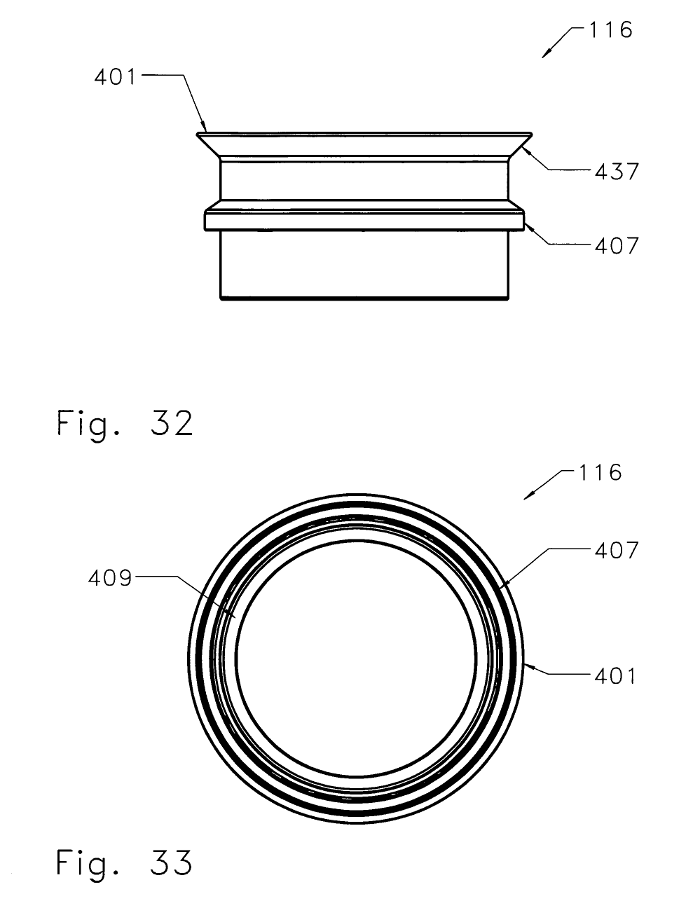

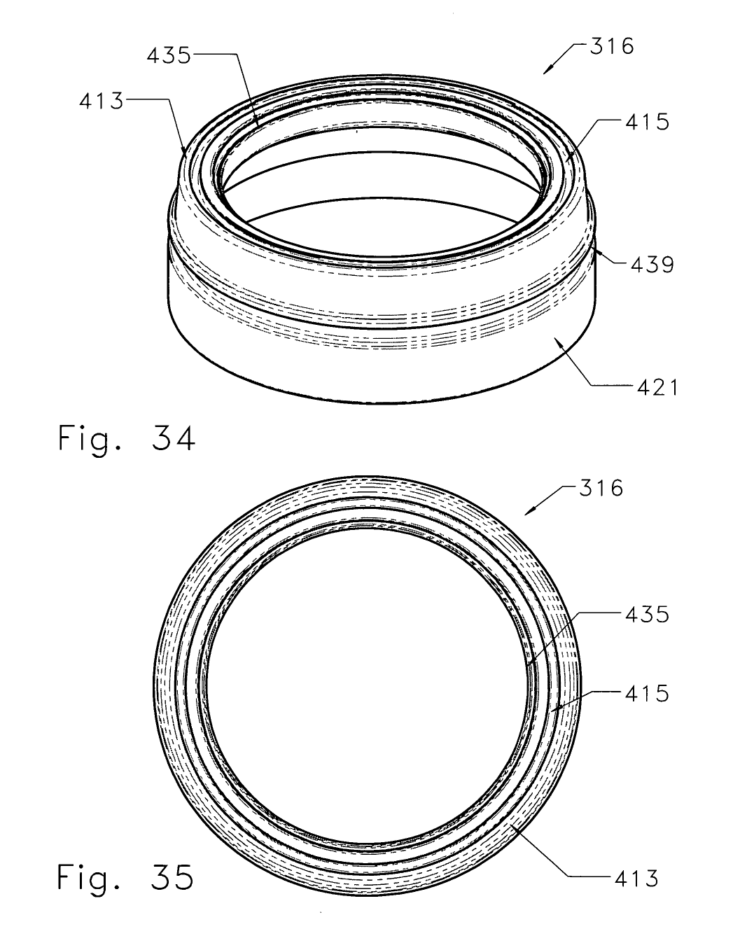

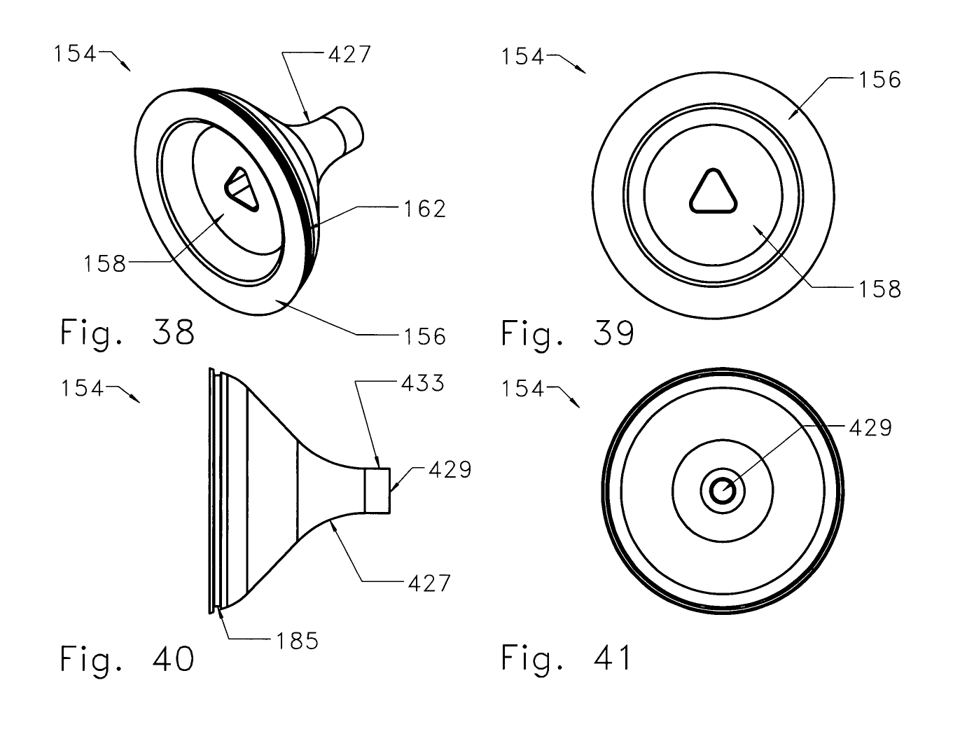

FIG. 30 shows a perspective view of inner sleeve 116 according to some embodiments, inner sleeve 116 being shaped as a quasi-cylindrical shell or sleeve having a hollow interior 405 and open top and bottom portions, a top 401 at its upper portion adjacent to which is annular groove 403. Inner sleeve 116 also features ring 407 co-extensively disposed about its outer wall, ring 407 being configured to receive inner spring 186 in a fashion that mechanically biases inner sleeve 116 outwardly from base 164 in a final assembled coupler 701. Annular seat 399 is configured and disposed to sealingly engage with o-ring 162 (FIG. 38) of poppet 154 in a coupler 701. FIG. 31 is an overhead view of inner sleeve 116, showing the respective locations of hollow interior 405, top 401 which is flat in some embodiments, and annular groove 403. A side perspective view of inner sleeve 116 is shown in FIG. 32, illustrating its outer wall, top 401, ring 407, and annular seat 437 which is configured to sealingly engage with annular seat 435 (FIG. 34) at the opening at the top of outer sleeve 316 in an assembled coupler 701. FIG. 33 is a bottom perspective view of an inner sleeve 116 according to some embodiments, showing the respective locations of top 401, ring 407.

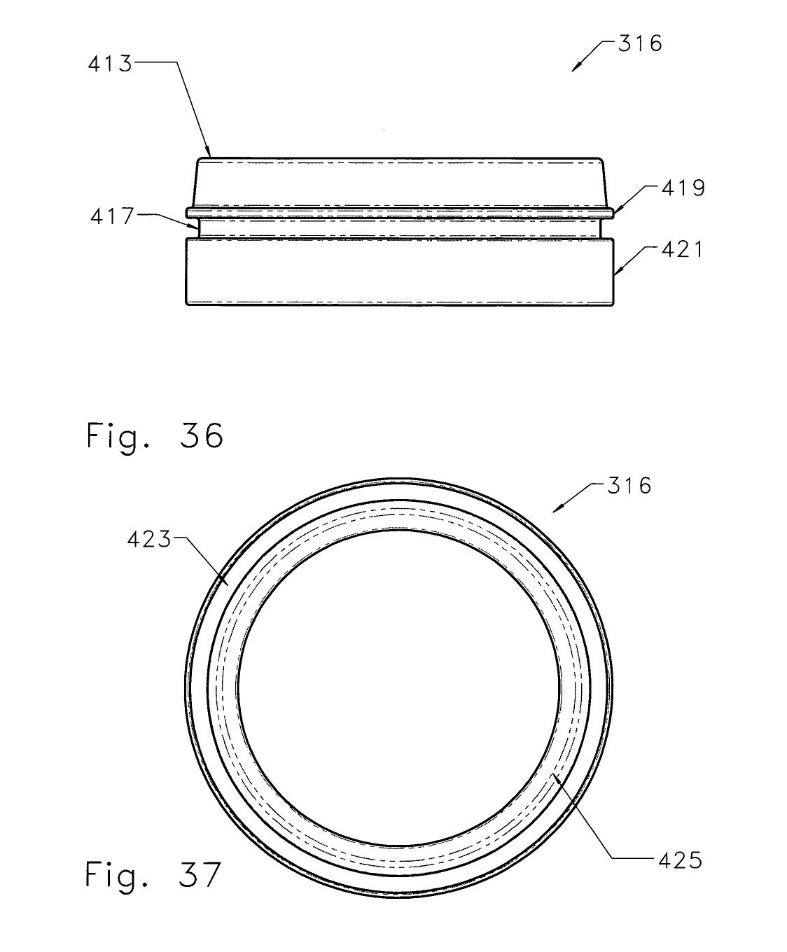

FIG. 34 is a perspective view of outer sleeve 316, shaped as a quasi-cylindrical shell or sleeve having a hollow interior and open top and bottom portions. The respective locations of top portion 413, skirt 421 and annular groove 415 that is configured to house an o-ring are depicted. Also shown is annular seat 435 that is configured to contain an o-ring that sealingly engages with annular seat 437 (FIG. 32) in a coupler 701 in some embodiments. Groove 439 is configured to receive an o-ring which makes a seal with the smooth inner bore 196 of coupler cover 144. FIG. 35 shows an overhead view of outer sleeve 316, including annular groove 415. In FIG. 36 is shown a side perspective view of outer sleeve 316, illustrating the respective locations of top 413, annular lip 419, annular groove 417, and skirt 421. In some embodiments the portion of outer sleeve 316 disposed above annular lip 419 and top portion 413 is angled or tapered. FIG. 37 is a bottom perspective view of outer sleeve 316 showing the respective locations of bottom 423 and surface 425.

FIG. 38 shows a perspective view of poppet 154 having a depressed region 158 interior to top surface 156, stem 427, and o-ring 162. Depressed region 158 is contoured to receive elevated portion 85 of poppet 100, enabling a somewhat interlocking and good contact surface area between poppet 154 and poppet 100 during coupling and uncoupling of couplers 700, 701.

FIG. 39 is an overhead view of poppet 154, showing top surface 156, and depressed region 158. FIG. 40 is a side perspective view of poppet 154 illustrating annular o-ring land 185 in which o-ring 162 (FIG. 38) is disposed, as well as stem 427 and its end 433, which includes a bore 429 for receiving poppet retainer 354, which in some embodiments is a short shaft. The location of bore 429 is also shown in the bottom perspective view of poppet 154 in FIG. 41.

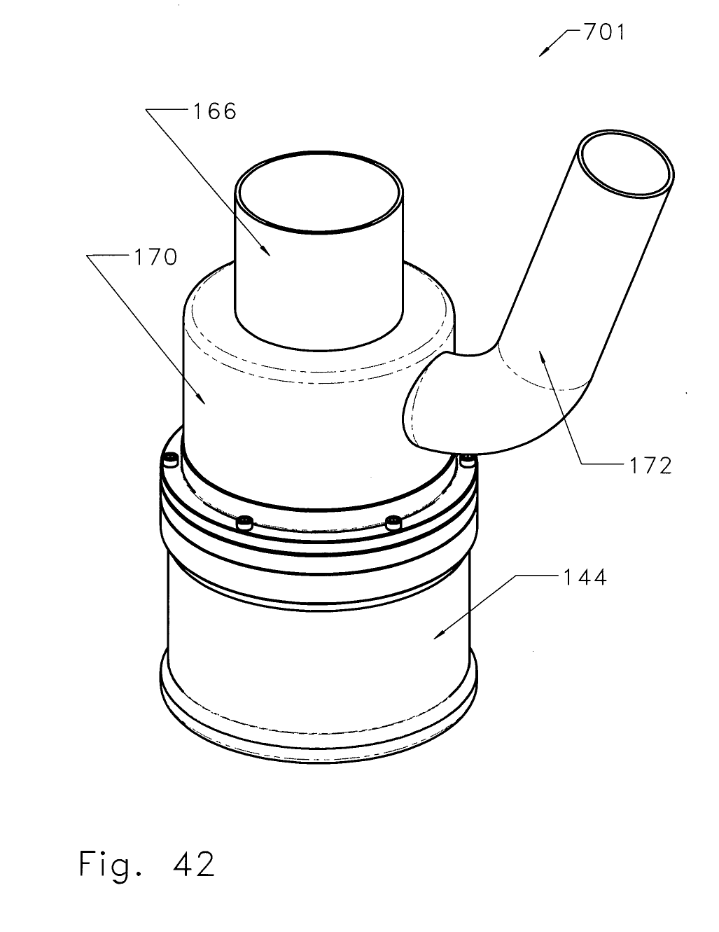

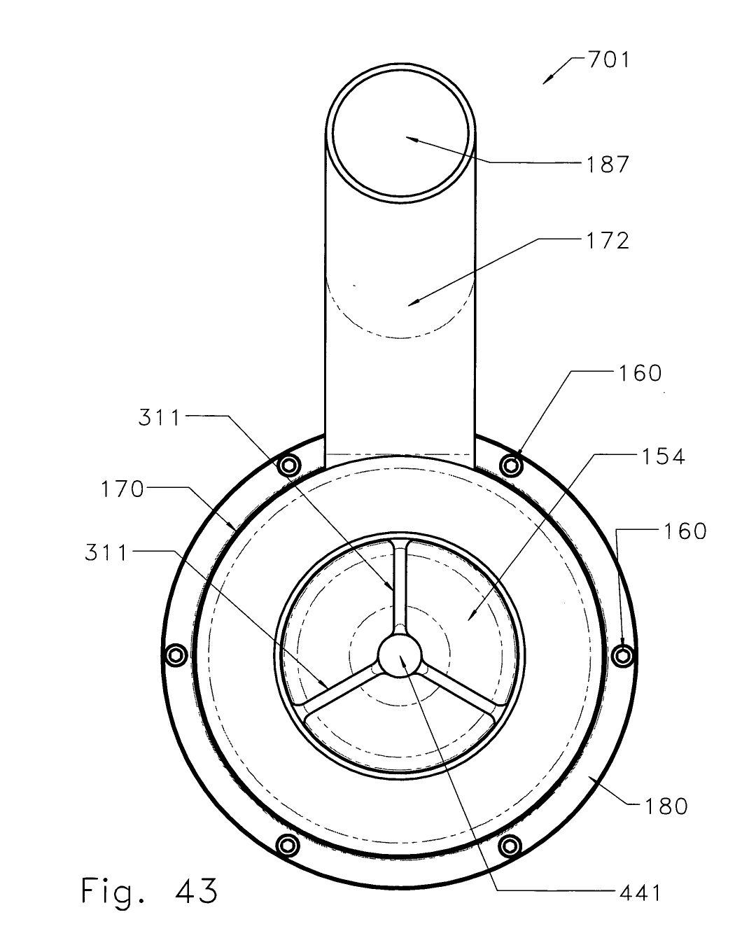

FIG. 42 shows a perspective view of coupler 701 in its assembled form, when components of FIG. 21 are contained within coupler cover 144 and coupler base 164. To assemble coupler 701, one orients coupler base 164 so that the bottom of the central conduit 166 and vapor tube 172 are facing downwards. Next, billet body 168 is placed onto coupler base 164 and springs 186 and 286 are placed over hub 370. The bottom portion of inner sleeve 116 is placed through the opening at the top 413 of outer sleeve 316, and inner and outer sleeves 116, 316 are then placed over springs 186, 286 and maintained by hand-applied bias against springs 186, 286, after which stationary poppet 154 and poppet retainer 354 are positioned and secured in place so the angled lower portion or seat 437 at top 401 engages with an o-ring present at annular seat 435 (FIG. 34). Poppet 154 is maintained in position in some embodiments by being its attached to poppet retainer 354 such as by complementary threads present inside poppet retainer bore 429 and on the exterior of poppet retainer 354. The remaining end of poppet retainer 354 is similarly secured to bore 320 of billet body 168 (FIG. 26). Coupler cover 144 is then secured in place using fasteners 160 (FIG. 21) which pass through holes 182 (FIG. 23) and into the threaded holes 152 (FIG. 29), securing the construct as a unit.

FIG. 43 is a bottom view of assembled coupler 701 showing the respective locations of flange 180, fasteners 160, supports 311, poppet 154, enclosure 170, flange 180, vapor tube 172, hub 441, and vapor tube outlet 187.

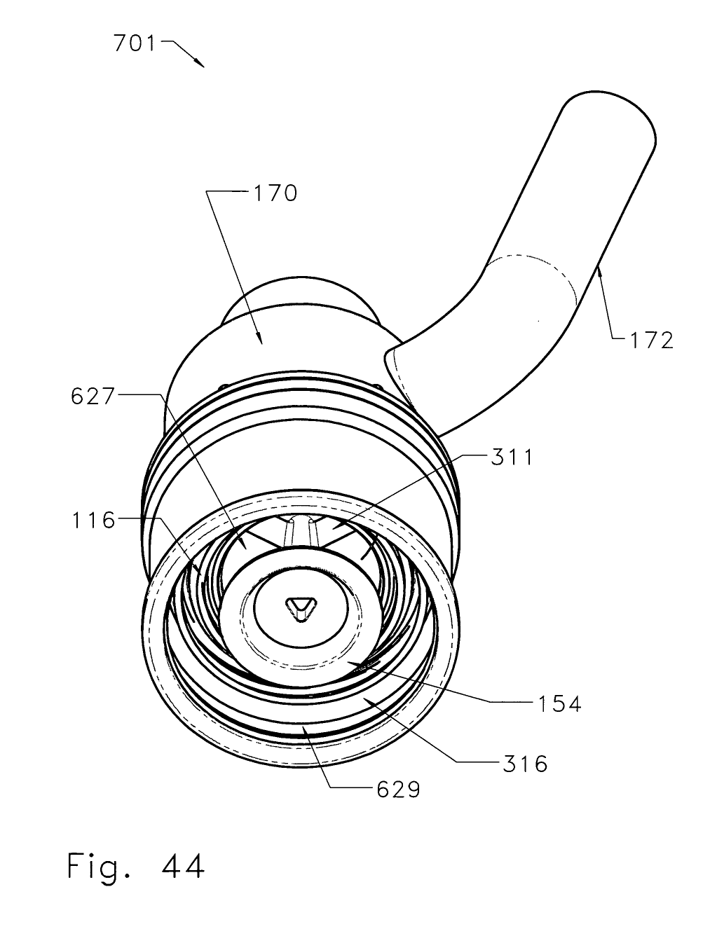

FIG. 44 is a perspective view of a coupler 701 when the inner sleeve 116 and outer sleeve 316 have been pushed against springs 186, 286, showing the respective locations of poppet 154, supports 311, inner sleeve 116, outer sleeve 316, enclosure 170 and vapor tube 172.

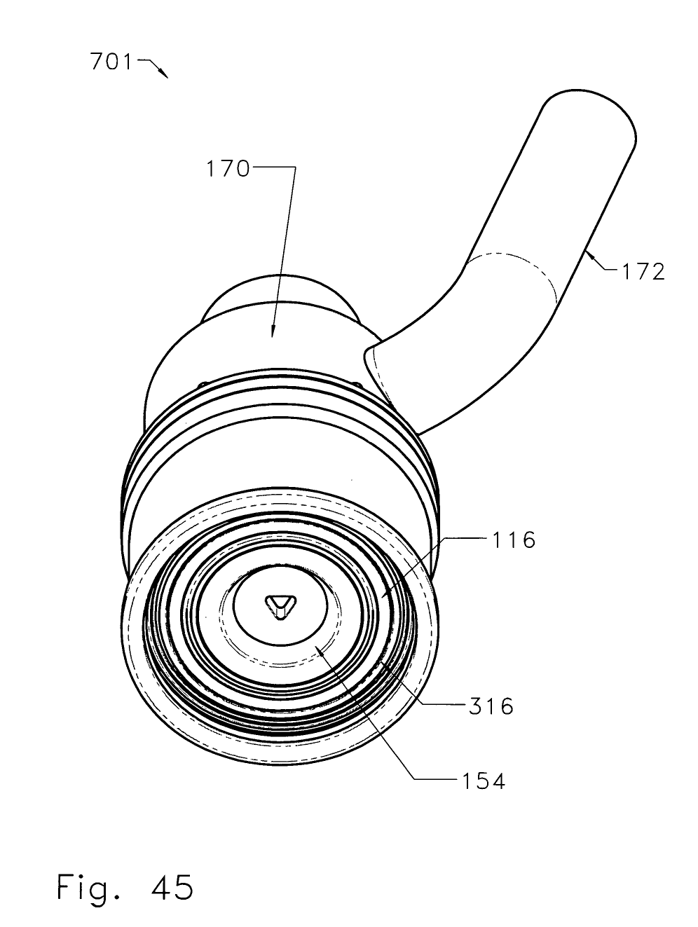

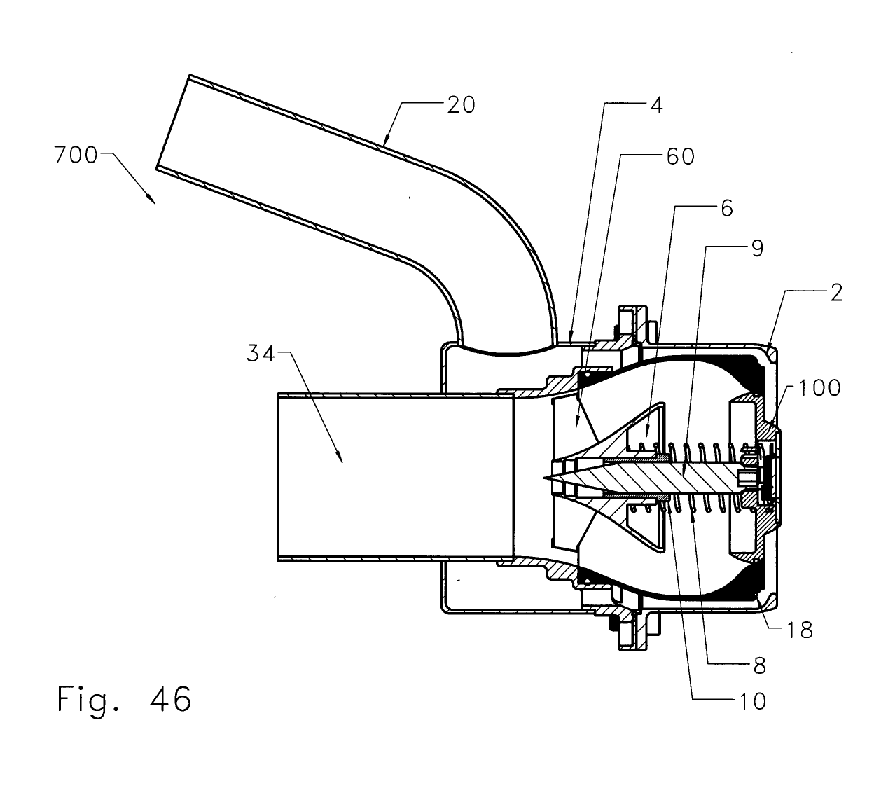

FIG. 45 is a perspective view of a coupler 701 in a closed position, showing the respective locations of poppet 154, inner sleeve 116, outer sleeve 316, enclosure 170 and vapor tube 172.

FIG. 46 is a side cutaway perspective view of an assembled coupler 700, showing the respective locations of vapor tube 20, coupler base 4, support arm 60, poppet guide 6, poppet shaft 9, spring 8, coupler cover 2, poppet 100, sleeve 18, poppet bushing 10, and central bore 34.

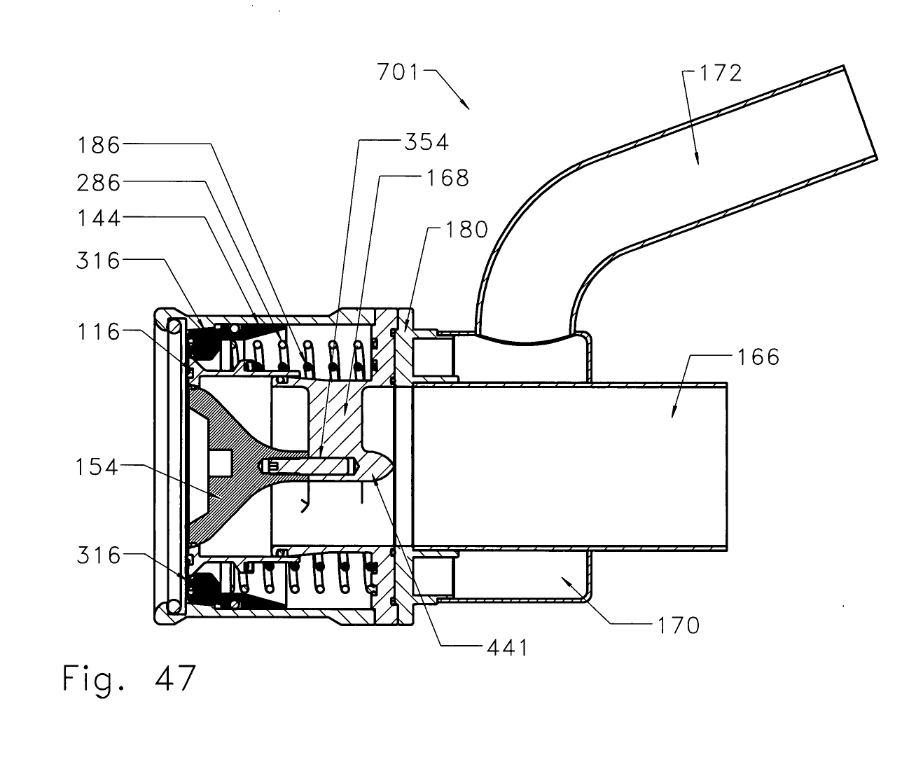

FIG. 47 is a side cutaway perspective view of an assembled coupler 701, showing the respective locations of vapor tube 172, central conduit 166, enclosure 170, hub 441, outer sleeve 316, poppet 154, inner sleeve 116, cover 144, outer spring 286, inner spring 186, poppet retainer 354, flange 180, and billet body 168.

Operation of a coupler 701 includes the following features. A force is applied to the surface 413 of outer sleeve 316 by top surface 3 of cover 2 of coupler 700, against the pressure of the spring 286 and substantially simultaneously, top surface 48 of sleeve 18 pushes against the top 401 of inner sleeve 116 against the pressure of spring 186. Each of outer sleeve 316 and inner sleeve 116 are forced against their respective spring pressure until they each bottom out by contacting base 368 of billet body 168. Outer sleeve 316 and inner sleeve 116 are configured so this action causes opening of a passage between outer sleeve 316 and inner sleeve 116 which constitutes a vapor passage 629 (FIG. 44) also shown in FIG. 48. In its contact with top 401 of inner sleeve 116, sleeve 18 makes a seal with an o-ring present in groove 403. The motion of inner sleeve 116 also opens a liquid passage 627 (FIG. 44) between poppet 154 and inner sleeve 116 that is separate and distinct from vapor passage 629, by virtue of annular seat 399 of inner sleeve 116 having been moved away from the o-ring seal 162 of the poppet 154. This enables liquid to pass through the interior of sleeve 18 and vapor being able to pass in a countercurrent direction to the travel of liquid along the exterior of sleeve 18.

FIG. 48 is a side cutaway perspective view of couplers 700, 701 when connected to one another, illustrating the path of vapor flow 409 and the path of liquid flow 411 during an operation in which a liquid is transferred from one vessel to another.

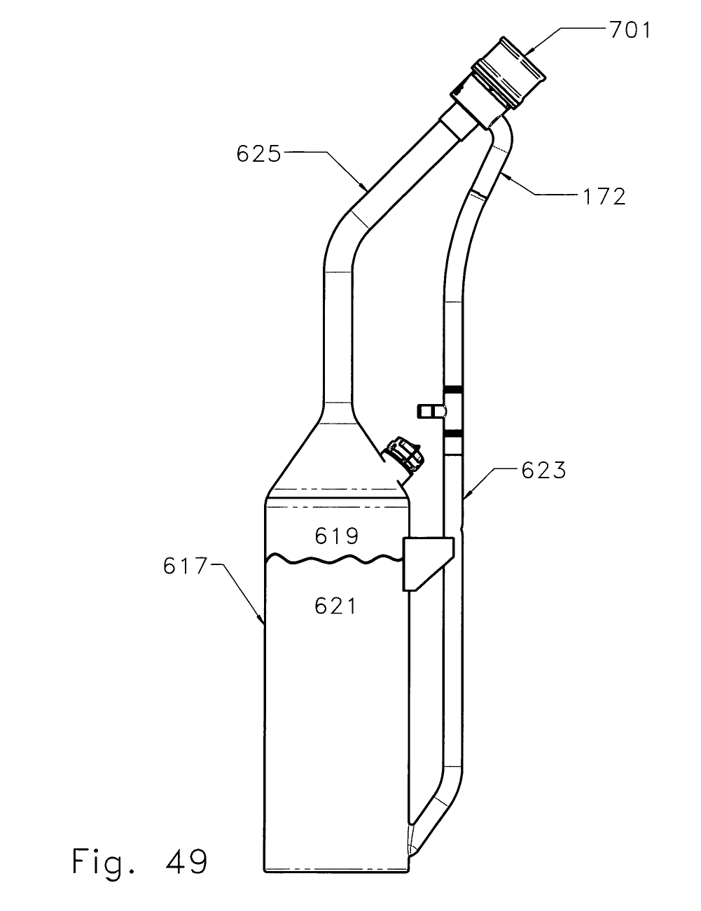

FIG. 49 shows a side view of a fuel containment vessel 617 comprising a fuel outlet conduit 625, vessel 617 containing a liquid fuel 621, and having a headspace 619 above the liquid fuel, and further comprising coupler 701 whose vapor tube 172 is in effective fluid communication with the headspace 619 above the fuel 621 in said fuel containment vessel 617 by means of a tubing 623, when vessel 617 is inverted to be upside-down of FIG. 49 such as during a vehicle re-fueling operation, said central conduit portion being in effective fluid communication with said outlet conduit 625. In some embodiments vessel 617 is a remote vessel meaning it holds only a few gallons of liquid and can be carried by one or two men, such as when it is desired to re-fuel a motorized vehicle using a coupling comprising the couplers 700, 701 such as a race car.

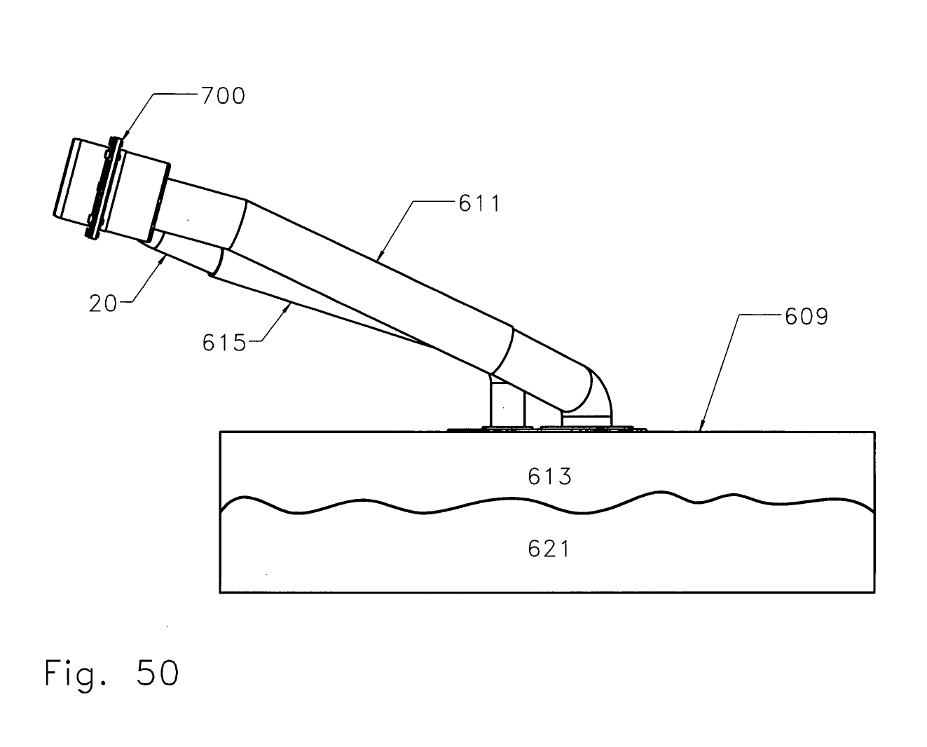

FIG. 50 shows a side perspective view of a fuel containment system comprising a fuel reservoir 609 having an inlet pipe 611 and containing a liquid fuel 621 and a headspace 613, and further comprising the coupler 700 whose vapor tube 20 is in effective fluid communication with the headspace 613 above the liquid fuel 621 in said reservoir by means of a tube 615, central bore 34 being in effective fluid communication with the inlet pipe 611.

In some embodiments, when male coupler 700 is engaged inside the female coupler cover and the two are pressed together by an applied force, a series of events occurs. Top surface 401 of inner sleeve 116 of coupler 701 contacts flat top surface 48 of sleeve 18. The applied force causes sleeve 18 to be pressed into the bore defined by wall W of coupler 700, thus making an opening at gap 637, which creates a fluid communication path between the outlet portion 35 of the vapor tube 20 and the location of opening 637. Continued applied force causes the inner sleeve 116 and outer sleeve 316 to be pushed by surfaces 48, 3 against pressure provided by springs 186, 286 into bore 196 of coupler cover 144, thus creating an opening at 189 (FIG. 18) through which a liquid or fuel, chemical, etc. may flow, also shown in FIG. 48. Continued application of force opens a space or passageway 627 (FIG. 44) between the outer top portion of inner sleeve 116 and the inner top portion of outer sleeve 316 in and around their juncture by virtue of inner sleeve 116 and outer sleeve 316 having been pushed to the limit of their possible travel, thus providing a fluid communication path between outlet portion 187 of vapor tube 172 and passage 627. Under such an arrangement, gap 637 of male coupler 700 and passage 629 of coupler 701 are in fluid communication, which also means that outlet portion 35 of vapor tube 20 and outlet portion 187 of vapor tube 172 are now in fluid communication with one another, and isolated from the passage through which liquid is to pass through the hollow interior of sleeve 18 and the interior of inner sleeve 116. During the course of the applied force, and more or less simultaneously with the aforesaid events for all practical purposes, top 156 of poppet 154 pushes on flat top surface 70 of poppet 100 against pressure of spring 8, thus creating opening 189 (FIG. 18), enabling fluid communication between opening 189 on coupler 700 and the opening 627 (FIG. 44) of coupler 701. Establishment of a fluid connection between the opening of opening 189 and the opening 627 means that there is now fluid communication between the bottom of the central conduit 166 and the central bore 34 of male coupler base 4. Thus, insertion of the male coupler cover 2 of the finished coupler 700 into the bore of the female coupler cover 144 of coupler 701 simultaneously causes a fluid communication to exist between the vapor tubes 20, 172 of each of the complementary couplers 700, 701 through a first passageway, and a fluid communication to exist between the central bore 34 of the male coupler base and the bottom of the central conduit 166 through a second passageway, which first and second passageways are separate from one another sufficiently to preclude the mixing of vapors present in vapor tubes 20, 172 and the liquid substance being transferred within couplers 700, 701.

In some embodiments, central bore 34 (FIG. 2) of coupler 700 is connected by conventional means such as a hose, piping or any other selected conduit to the inlet pipe through which a receiving vessel such as a fuel tank is replenished with liquid, and the outlet portion 35 of the vapor tube 20 is connected by conventional means such as a hose to the headspace above the fuel in a fuel tank.

In some embodiments, coupler 701 is fitted to the bottom of a portable fuel reservoir, or alternately to a pump outlet. The outlet portion 187 of the vapor tube 172 is connected by conventional means such as a hose to be in fluid communication with the headspace above the fuel in the fuel reservoir from where the fuel to be delivered to the vehicle is stored. In some embodiments, central conduit 166 is connected by conventional means such as a hose to the bottom of the portable reservoir and thus in fluid communication with a liquid reservoir.

Using such provisions, when it is deemed desirable to transfer a fluid such as when filling gasoline to a vehicle, affixing the end of the coupler 701 onto the open end of the coupler 700 causes the above-described events to occur, and effectively simultaneously, i.e., within about less than 1 second, permits transfer of fluids from one location to another with no loss of vapor to the atmosphere. Also, since the volume of fuel delivered from the storage tank to the fuel tank on the vehicle is simultaneously compensated for by an equal exchange of headspace volume as between the two fuel storage vessels when using the provisions of this specification, inhibition of liquid flow is greatly reduced. Owing also to the nature of the coupling's internal geometry and configuration, losses of fuel due to spillage are kept to an absolute minimum, thus reducing health, fire, and environmental hazards associated with spills of chemical liquid substances including without limitation motor gasolines.

In some embodiments, vent disc 14 on the coupler 700 is spring-loaded, whose purpose is to enable ambient air to enter the fuel tank after a quantity of fuel has been removed from the fuel tank by the action of the engine's fuel pump during normal operation. In some embodiments, once the vacuum inside the fuel tank reaches a sufficient level that spring 12 can no longer hold vent disc 14 in its seated position, the vent disc is drawn away from retainer ring 16, and enables ambient air to enter the tank to compensate for the loss of fuel or other cause of vacuum in the tank, including decreases in ambient temperature. In addition, vent disc 14 includes hole 15 in its surface, which orifice enables excess pressure which may build up in the tank, owing to increases in temperature or other causes to be automatically vented to the ambient atmosphere.

In some embodiments, a bore can be considered as being synonymous with a conduit with respect to the liquid passage through a coupler. In some embodiments, an element as taught herein can be effectively spring biased without directly contacting a spring itself, such as sleeve 18 is spring biased by virtue of its being in effective mechanical contact with poppet 100, which itself is spring biased. The seal between sleeve 116 and the periphery of poppet 154 is a spring-biased seal.

Consideration must be given to the fact that although various aspects of the invention have been described and disclosed in relation to certain embodiments, obvious equivalent modifications and alterations of components and their cooperative function as taught herein may become apparent to one of ordinary skill in this art after reading and understanding this specification and the claims appended hereto. Such modifications and alterations include substitution of different geometries of components described herein, such as for example the use of a rectangular, ovoid, or other-shaped sleeves 18, 116, 316 and bases and other components complementary thereto in terms of function. In some embodiments, central conduit 166 and central bore serve the same general function, as each comprise a portion of a conduit through which a liquid is intended to flow through couplers 700, 701.

What is claimed is:

1) A coupler useful for transferring a liquid from a first reservoir to a second reservoir, comprising:
a) a base having a central bore,
b) a cover attached to said base;
c) a quasi-cylindrical sleeve slidably disposed within said cover, said quasi-cylindrical sleeve having a top, a bottom, an opening, a hollow interior, an interior wall, and an exterior wall;
d) a poppet disposed at said opening of said sleeve, said poppet having a periphery and being configured and disposed to make a selectively engageable seal between said opening and said periphery,
said seal between said opening and said periphery being maintained by at least one of said sleeve or said poppet being effectively spring-biased towards a closed position, said sleeve being configured sufficiently to enable, upon sufficient separation of said opening from said periphery, the opening of a first passage suitable for flow of a liquid therethrough, and the opening of a second passage that is separate and distinct from said first passage suitable for flow of a vapor therethrough, the first passage being through the interior of said sleeve and the second passage being exterior to the wall of said sleeve, said exterior wall comprising a portion of the boundary of the second passage.

2) A coupler according to claim 1, said central bore having an exterior and further comprising an enclosure disposed about the exterior of said central bore through which vapors may pass.

3) A coupler according to claim 1, said cover comprising an inner bore, and wherein said sleeve is slidably disposed within said bore.

4) A coupler according to claim 1, wherein said poppet is stationary.

5) A coupler according to claim 1, wherein said poppet is spring-biased and slidably disposed within said cover.

6) A coupler according to claim 5 wherein said poppet is affixed to a shaft, said shaft being slidably disposed within a guide present within said coupler, said guide being shrouded in part by a cone having a diameter that substantially matches a diameter present on said poppet.

7) A coupler according to claim 1 wherein at least a portion of said second passage is concentrically disposed about said first passage.

8) A coupler according to claim 1 wherein said sleeve is effectively spring-biased towards a closed position with respect to said periphery of said poppet.

9) A coupler according to claim 1 wherein said central bore includes a transition between a first diameter present in said central bore and the dimension of said interior wall of said sleeve at its bottom when said sleeve is in an open position, said transition comprising a tapered segment.

10) A coupler useful for transferring a liquid from a first reservoir to a second reservoir, comprising:
a) a base having a central conduit,
b) a cover attached to said base;
c) a quasi-cylindrical sleeve slidably disposed within said cover, said quasi-cylindrical sleeve having an opening, a hollow interior, and an exterior wall;
d) a poppet slidably disposed at said opening of said sleeve, said poppet having a periphery and being configured and disposed to make a selectively engageable seal between said opening and said periphery,
said seal between said opening and said periphery being maintained by said poppet being effectively spring-biased towards a closed position, said sleeve being configured sufficiently to enable, upon depression of said poppet against the force of said spring, separation of said opening from said periphery and movement of said sleeve sufficient to open a first passage suitable for flow of a liquid therethrough, and the opening of a second passage that is separate and distinct from said first passage suitable for flow of a vapor therethrough, the first passage being through the interior of said sleeve and the second passage being exterior to the wall of said sleeve, said exterior wall comprising a portion of the boundary of the second passage.

11) A coupler according to claim 10, said conduit having an exterior, and further comprising an enclosure disposed about the exterior of said conduit through which vapors may pass, said enclosure having a vapor tube attached thereto and configured to enable fluid communication between said vapor tube and said exterior of said wall of said sleeve adjacent to said opening.

12) A coupler according to claim 10, said cover comprising an inner bore, and wherein said sleeve is slidably disposed within said bore.

13) A coupler according to claim 10 wherein at least a portion of said second passage is concentrically disposed about said first passage.

14) A coupler according to claim 10 wherein said sleeve is effectively spring-biased towards a closed position with respect to said periphery of said poppet.

15) A coupler useful for transferring a liquid from a first reservoir to a second reservoir, comprising:
a) a base having a central conduit,
b) a cover attached to said base;
c) a quasi-cylindrical first sleeve slidably disposed within said cover, said first sleeve having an opening, a hollow interior, and an interior wall;
d) a quasi-cylindrical second sleeve, said second sleeve having an opening, a hollow interior, an exterior wall featuring a seat, and being slidably disposed within said cover at said opening of said first quasi-cylindrical sleeve sufficiently to form a first selectively engageable seal between said seat and said opening of said first sleeve;
e) a stationary poppet disposed at said opening of said second sleeve, said poppet having a periphery and being configured to make a second selectively engageable seal between said opening of said of second sleeve and said periphery,
said seals being maintained by said sleeves being effectively spring-biased towards a closed position, said sleeves being configured sufficiently to enable, upon sufficient separation of said opening of said second sleeve from said periphery, the opening of a first passage suitable for flow of a liquid therethrough, and the opening of a second passage that is separate and distinct from said first passage suitable for flow of a vapor therethrough, the first passage being through the interior of said second sleeve and the second passage being bound by the exterior to the wall of said second sleeve and the interior wall of said first sleeve.

16) A coupler according to claim 15, said conduit having an exterior, and further comprising an enclosure disposed about the exterior of said conduit through which vapors may pass, said enclosure having a vapor tube attached thereto and configured to enable fluid communication between said vapor tube and the space between the walls of said sleeves.

17) A coupler according to claim 15, said cover comprising an inner bore, and wherein said first sleeve is slidably disposed within said bore.

18) A coupler according to claim 15 wherein at least a portion of said second passage is concentrically disposed about said first passage.

19) A coupler according to claim 15 wherein said sleeves are spring-biased towards a closed position with respect to said periphery of said poppet and to one another.

20) A coupler useful for facilitating transfer of a liquid from a first vessel to a second vessel with countercurrent transfer of vapor from the second vessel to the first vessel, comprising: a spring-biased quasi-cylindrical sleeve slidably disposed within a cover, said sleeve being hollow and having an interior and an exterior wall, said exterior wall being configured sufficiently to cause, upon application of force against the pressure of said spring, the opening of a first passage through which liquid is able to pass, and the opening of a second passage that is separate and distinct from said first passage through which vapor is able to pass within said coupling fitting, the first passage being disposed through the interior of said sleeve and the second passage being disposed exterior to the wall of said sleeve, said exterior wall comprising a portion of the boundary of said second passage.
